(19) United States
(12) Patent Application Publication
(10) Pub. No.: US 2026/0124834 A1
(43) Pub. Date: May 7, 2026

(54) COMPUTER IMPLEMENTED METHOD FOR CLEANING A SELF-CLEANING HEAD

(71) Applicant: Videojet Technologies Inc., Wood Dale, IL (US)

(72) Inventors: Michael Jeffrey Stamp, Cambridgeshire (GB); David Andrew Horsnell, Cambridgeshire (GB); John Folkers, Cambridgeshire (GB); Amy Malevany, Cambridgeshire (GB); Cac Diem Duc Nguyen, Cambridgeshire (GB)

(21) Appl. No.: 19/141,149

(22) PCT Filed: Dec. 20, 2023
(86) PCT No.: PCT/GB2023/053328

§ 371 Date: Jun. 19, 2025

(30) Foreign Application Priority Data
Dec. 20, 2022 (GB) 2219230.6

(51) Int. Cl. B41J 2/165; B41J 29/393

(52) U.S. Cl. CPC B41J 2/16552; B41J 29/393; B41J 2002/16573

(57) ABSTRACT

There is provided a computer implemented method for cleaning a self-cleaning marking head of an industrial printer, the method comprising, receiving, by the industrial printer and from an external controller, a control signal and executing, by the industrial printer, a self-cleaning operation of the self-cleaning marking head in response to receiving the control signal.

The present disclosure relates to a method of externally triggering maintenance of a self-cleaning marking head.

Industrial printers, such as continuous inkjet printers, are typically used on production lines where products travelling along the production line are marked as they pass the continuous inkjet printer. In order to maintain operation of such printers, it is necessary to perform maintenance on the continuous inkjet printer. For example, continuous inkjet printers require that some of their components such as their deflection plates or gutters need to be cleaned in order to prevent the build-up of material that could affect printing quality. However, in order to clean a continuous inkjet printer that is operating on a production line, it is necessary to stop the production line and move a print head of the printer to a cleaning position. The cleaning position may be a position in which an external cleaning apparatus can gain access to the print head. Alternatively, the entire print head may need to be removed from the continuous inkjet printer and taken to a cleaning station to be cleaned.

There exists a need to provide alternative methods and apparatuses that overcome one or more of the disadvantages of known systems, whether mentioned in this document or otherwise.

In a first aspect there is provided a computer implemented method for cleaning a self-cleaning marking head of an industrial printer, the method comprising, receiving, by the industrial printer and from an external controller, a control signal, and executing, by the industrial printer, a self-cleaning operation of the self-cleaning marking head in response to receiving the control signal.

Advantageously, the method enables a cleaning operation to take place with minimal disruption to a printing operation. A printing operation may be one such as marking objects or products on a production line. The external controller is external to the industrial printer. For example, the external controller could be a production line controller (e.g. a filling machine, weighing machine, cutting machine, or any other production equipment that operates on the production line). The external controller may have an overview of the running of the production line, and so can select an appropriate time to carry out cleaning, such as when the production line is halted. That is, the external controller may allow coordination of cleaning with production line downtime by only sending the control signal at the appropriate time. The control signal may take any suitable form, configured such that receipt of the control signal by the industrial printer causes the industrial printer to carry out the self-cleaning operation.

Executing, by the industrial printer, a self-cleaning operation of the self-cleaning marking head in response to receiving the control signal may comprise executing, by a processor of the industrial printer, the self-cleaning operation of the self-cleaning marking head in response to receiving the control signal. That is, an internal controller, or processor, within the industrial printer may, on receipt of the control signal, cause the industrial printer to execute the self-cleaning operation of the self-cleaning marking head.

Alternatively, the industrial printer (e.g. the processor or internal controller of the industrial printer) may determine that there is a service issue, for example by using one or more sensors of the industrial printer, or determine that a condition has been met, and in response send a message to the external controller to alert the external controller to the service issue. The external controller can then determine an appropriate time to send the control signal to the industrial printer to initiate cleaning.

The condition may be a scheduled time. For example, the scheduled time may be a predetermined time known to the industrial printer by which the printer should carry out a self cleaning operation of the marking head.

The condition may be a determination that no products have passed by the industrial printer for a predetermined period of time. For example, the industrial printer may have sensors (or access to data from external sensors), that detect the passing of products as they travel along a conveyor. If no products have passed by the industrial printer in the predetermined period of time, it may be assumed that the production line is idle and a self-cleaning operation of the self-cleaning marking head can be performed without holding up the production line. Sensor data may be combined with temporal data. For example, the condition may be both a determination that no products have passed by the industrial printer for a predetermined period of time and a determination that the present time corresponds to the scheduled time described above.

The condition may comprise historical data. For example, the historical data may comprise an elapsed time and/or number of prints since a last failure event. For example, if it is determined that there has been an elapsed time and/or number of prints since a last failure event, the industrial printer may determine that the condition has been met.

The historical data may comprise data indicating the average time between failures. For example, if it is determined that the industrial printer is approaching, or has reached, the average time before failure, the industrial printer may determine that the condition has been met.

The historical data may comprise data indicating marking medium (e.g. ink) usage. For example, if a predetermined amount of marking medium has been used, the industrial printer may determine that the condition has been met.

The historical data may comprise data indicating the mark being applied to the product and/or a number of individual marking actions (e.g. number of printed drops in the case of a continuous ink jet printer). For example, if a predetermined number of marks have been applied, or a predetermined number of individual marking actions have occurred, the industrial printer may determine that the condition has been met.

The historical data may comprise data indicating historical environmental data, such as the ambient humidity, temperature, and/or pressure in the environment in which the industrial printer is operating. The environmental data may be collected over a predetermined period in which the industrial printer has been operating in. If the environmental data meets a predetermined condition, such as one or more of the humidity, temperature and/or pressure being above (or below) a certain level for certain period of time, the industrial printer may determine that the condition has been met.

By providing a self-cleaning operation, there is a further reduction in disruption to the printing operation as there is no requirement for the marking head to be moved to a specific position to allow access for an external cleaning apparatus.

The industrial printer and external controller may comprises one or more processors configured to carry out the steps of the methods disclosed herein. The industrial printer and external controller may also comprise computer readable memory configured to store non-transitory computer readable instructions, that, when executed by the one or more processors, cause the printer to carry out the methods disclosed herein. The industrial printer may be coupled to the external controller such that data can be exchanged between the industrial printer and the external controller. Such coupling may comprises a wired or wireless connection, using any suitable protocol that facilitates the exchange of data.

An industrial printer is a printer used in an industrial setting. For example, industrial printers are typically used on production lines to mark products travelling along the production line. The industrial printer may be a non-contact printer. The industrial printer may be a continuous inkjet printer, drop on demand printer, or laser printer.

The marking head is configured to apply a mark to a product, using a marking medium. The marking head may be a print head or laser. The marking medium may comprise ink in the case of a continuous inkjet printer or photons in the case of a laser.

The self-cleaning operation may comprise an intrinsic cleaning operation.

The intrinsic cleaning operation is a cleaning operation that does not require the use of external cleaning apparatus. That is, the self-cleaning marking head is cleaned in situ, and does not require moving from its normal printing position (e.g. the normal position the marking head would be in when applying marks to products) to a cleaning position (e.g. a position at which an external cleaning apparatus is located, or a position that allows an external cleaning apparatus to access the marking head for cleaning). For example, it is not required that the self-cleaning marking head be moved away from the surface of a substrate (e.g. the surface of a product) on which the self-cleaning marking head is applying a mark in order to allow space for an external cleaning apparatus to gain access to and clean the self-cleaning marking head. The self-cleaning marking head can instead remain in position while it performs its self-cleaning operation.

The self-cleaning operation may not comprise the use of an external cleaning apparatus.

An external cleaning apparatus is an apparatus separate from the self-cleaning marking head and/or the industrial printer. An external cleaning apparatus may be an apparatus that requires a marking head to be moved from a normal printing position to a cleaning position in order to perform cleaning as noted above. For example, the external cleaning apparatus may require access to the marking head that would otherwise not be available if the marking head is in its normal printing position.

The industrial printer may be a continuous inkjet printer and the self-cleaning marking head may be a self-cleaning print head.

The self-cleaning operation may be executed by a processor of the industrial printer, the processor of the industrial printer being separate from the external controller. That is, control logic used to actuate the various components of the industrial printer, described below, in order to carry out the self-cleaning operation, may be executed by the processor of the industrial printer.

The self-cleaning operation may comprise actuating a sealing mechanism of the self-cleaning print head from a first configuration, in which a chamber of the self-cleaning print head is in communication with atmosphere via at least an ink aperture, to a second configuration in which the chamber is sealed.

Sealing is intended to encompass the chamber being in fluid communication with one or more conduits, preferably a plurality of conduits. At least one conduit may be for supplying the chamber with cleaning fluid. At least one conduit may be for draining used/spent/dirty cleaning fluid from the chamber. Each of the conduits is preferably closeable under action of a respective valve. Each of the conduits is preferably bidirectional insofar as the conduit can either supply cleaning fluid, or drain used cleaning fluid, depending upon the configuration.

Advantageously, the chamber is sealed and can be cleaned in an automated manner, along with any components disposed within the chamber (e.g. deflection electrode).

The chamber may comprise one or more ports. A port may be considered to be an opening in the surface of the chamber. One or more of the ports may couple to one or more of the conduits.

The self-cleaning print head may comprise a nozzle for generating and ejecting a stream of ink droplets for printing, at least one electrode for guiding the stream of ink droplets, and a gutter for receiving droplets of ink which are not used for printing. The at least one electrode may be disposed in the chamber.

The ink aperture may form part of an ink channel, such as an ink slot. It is through the ink aperture that deflected ink, in operation, is ejected from the print head onto a substrate (e.g. an external substrate, such as a surface of a product to be marked). That is, once ink has been ejected from a nozzle of the print head, the ejected ink then travels through the ink aperture to exit the chamber and land on the substrate. In the first configuration, the ink aperture is open such that ink can travel out of the chamber. In the second configuration, the ink aperture is closed such that ink cannot travel out of the chamber, e.g. the chamber is sealed to the external atmosphere.

The self-cleaning operation may further comprise directing a cleaning fluid into the chamber to clean the chamber.

The chamber may be referred to as a cleaning chamber. The cleaning fluid may be solvent. The cleaning fluid may be a blend of solvents.

Directing the cleaning fluid into the chamber may comprise pumping cleaning fluid into the chamber (e.g. under a positive pressure).

Directing the cleaning fluid into the chamber may comprise sucking (e.g. drawing) cleaning fluid into the chamber, under a negative pressure. Cleaning fluid may subsequently be drawn out of the chamber, again under a negative pressure. Advantageously, a gutter pump can be used to draw the cleaning fluid in this manner. Drawing cleaning fluid under a negative pressure is advantageously failsafe insofar as if the sealing mechanism were to fail, no cleaning fluid would be drawn into the chamber owing to the negative pressure drawing in only air via the open sealing mechanism. Such an arrangement is therefore inherently failsafe in mitigating the risk that pressurised cleaning fluid be inadvertently ejected from the print head onto a printing line (e.g. products on a production line).

The method may further comprise draining used cleaning fluid from the chamber. Used cleaning fluid may be drained contemporaneously as (new/fresh) cleaning fluid is pumped into the chamber. That is to say, cleaning fluid may be actively pumped or drawn through the chamber. Alternatively, the cleaning fluid may occupy the chamber for a period of time before being subsequently drained (e.g. a dwell time, or dwell period, such as around 5 seconds). That is to say, cleaning fluid may reside in the chamber in a stagnant manner for a period of time. The cleaning fluid may therefore dwell in the cleaning chamber for a time. Cleaning fluid drained from the chamber may be stored in a separate fluid reservoir (e.g. separate to the mixer tank). The separate fluid reservoir may be selectively connectable to the mixer tank to maintain viscosity.

The cleaning fluid may be directed into the chamber from a solvent reservoir (e.g. a solvent tank). The solvent reservoir may contain solvent which has previously been used in an ink system. The cleaning fluid may be directed into the chamber from a solvent cartridge. The solvent cartridge may contain fresh, or virgin, solvent. A cleaning cycle may first be carried out using cleaning fluid from the solvent reservoir. The cleaning cycle may then be carried out using fresh cleaning fluid from the solvent cartridge. This may be described as pre-cleaning with dirty solvent, and finishing the cleaning cycle with a virgin solvent rinse. Cleaning the chamber may comprise agitating the cleaning fluid, in the chamber, by directing a flow of air through the chamber. This may be described as bubbling air through the chamber to agitate the cleaning fluid in the chamber.

Where the chamber is in fluid communication with a plurality of conduits, the conduits are preferably connected to the chamber at different locations. For example, a first conduit may be connected to an upstream end of the chamber (e.g. proximate the nozzle). For example, a second conduit may be connected to a downstream end of the chamber (e.g. proximate the gutter). Ports, to which the conduits are connected, are preferably provided at diametrically opposed locations with respect to one another in the chamber. For example, a first port may be disposed in a first corner of a cuboidal chamber, and the second port may be disposed at a diagonally opposed second corner of the cuboidal chamber.

The sealing mechanism may comprise a rotatable body rotatable about an axis of rotation between the first configuration and the second configuration, and wherein actuating the sealing mechanism of the self-cleaning print head from the first configuration to the second configuration comprises rotating the rotatable body of the sealing mechanism of the self-cleaning print head from the first configuration to the second configuration in which the chamber is sealed by the rotatable body.

The chamber may comprise a plurality of ports, and the method may further comprise selecting, by the continuous inkjet printer, a port of the chamber as a fill port, and a port of the chamber as a drain port, based upon the orientation of the self-cleaning print head, wherein directing the cleaning fluid into the chamber to clean the chamber comprises directing a flow of cleaning fluid through the fill port, into the cleaning chamber, to clean the cleaning chamber, and draining the cleaning fluid from the cleaning chamber, through the drain port, to drain the cleaning chamber.

The method may further comprise detecting, by continuous inkjet printer, the orientation of the self-cleaning print head using an orientation sensor.

The orientation sensor may be configured to output an orientation signal indicative of the orientation of the self-cleaning print head. On receiving the orientation signal indicative of the orientation of the self-cleaning print head, the continuous inkjet printer may output a valve control signal, to a plurality of valves, to control the flow of cleaning fluid into and/or out of the chamber based upon the orientation of the self-cleaning print head, wherein the plurality of valves are operable to control a flow of cleaning fluid flow into and/or out of the chamber.

The control signal may have been sent based on a predetermined condition being satisfied.

The predetermined condition may be a status of a production line on which the industrial printer is operating. The status may comprise a halt on the production line on which the industrial printer is operating. For example, if the production line is halted due to failure of a component on the production line, the self-cleaning operation may take place while the production line is halted, taking advantage of the unexpected downtime.

The predetermined condition may comprise a predetermined time. For example, the production line may be scheduled to halt at the predetermined time in order to carry out maintenance, or change over of products to be marked. Therefore, the predetermined time may be a predetermined maintenance time or product change over time.

The method may further comprise sending, by the external controller, the control signal to the industrial printer.

The external controller may send the control signal due to a determination by the external controller that a predetermined condition is satisfied as noted above. For example, the external controller may determine that the production on the production line has been halted due to an unscheduled event, such as a failure of a component other than the industrial printer. In this way, the cleaning of the marking head can take place at times at which the production line is down, without having to unnecessarily halt the production line to clean the marking head.

The computer implemented method may further comprise determining, by the industrial printer, completion of the self-cleaning operation, and sending, by the industrial printer, data indicating that the self-cleaning operation is complete to the external controller.

In this way, the external controller is kept informed about the status of the industrial inkjet printer.

In a second aspect there is provided a computer implemented method for cleaning a self-cleaning marking head of an industrial printer, the method comprising, obtaining, by the industrial printer, sensor data indicative of an operation of the self-cleaning marking head, determining, by the industrial printer, a service issue associated with the self-cleaning marking head based on the sensor data, and executing, by the industrial printer, a self-cleaning operation of the self-cleaning marking head in response to the determined service issue.

Advantageously, the industrial printer is able to determine a service issue associated with the self-cleaning marking head that could potentially affect printing performance and automatically take action by initiating a cleaning operation to remedy the service issue. The service issue may be the detection of a build-up of debris, for example, in or around a nozzle, gutter or deflection plates of the marking head, or could be the detection of an EHT trip. Automatically taking action to carry out a self-cleaning operation dispenses with the need for an operator to manually initiate cleaning or for the cleaning to be manually carried out.

The self-cleaning operation may be as set out within the present disclosure. The self-cleaning operation may be self-cleaning in that it does not require the self-cleaning marking head to be cleaned extrinsically, e.g. using external cleaning apparatus.

The industrial printer may be configured to operate on a production line, applying marks to products on the production line. The determination of the service issue may be determined while the industrial printer is using the self-cleaning marking head to mark products on the production line.

The sensor data may be obtained from one or more sensors associated with the printer and/or the self-cleaning marking head.

The industrial printer may be a continuous inkjet printer and the self-cleaning marking head may be a self-cleaning print head.

The self-cleaning operation may comprise actuating a sealing mechanism of the self-cleaning print head from a first configuration, in which a chamber of the self-cleaning print head is in communication with atmosphere via at least an ink aperture, to a second configuration in which the chamber is sealed.

Sealing is intended to encompass the chamber being in fluid communication with one or more conduits, preferably a plurality of conduits. At least one conduit may be for supplying the chamber with cleaning fluid. At least one conduit may be for draining used/spent/dirty cleaning fluid from the chamber. Each of the conduits is preferably closeable under action of a respective valve. Each of the conduits is preferably bidirectional insofar as the conduit can either supply cleaning fluid, or drain used cleaning fluid, depending upon the configuration.

Advantageously, the chamber is sealed and can be cleaned in an automated manner, along with any components disposed within the chamber (e.g. deflection electrode).

The chamber may comprise one or more ports. A port may be considered to be an opening in the surface of the chamber. One or more of the ports may couple to one or more of the conduits.

The self-cleaning print head may comprise a nozzle for generating and ejecting a stream of ink droplets for printing, at least one electrode for guiding the stream of ink droplets, and a gutter for receiving droplets of ink which are not used for printing. The at least one electrode may be disposed in the chamber.

The ink aperture may form part of an ink channel, such as an ink slot. It is through the ink aperture that deflected ink, in operation, is ejected from the print head onto a substrate (e.g. an external substrate, such as a surface of a product to be marked). That is, once ink has been ejected from a nozzle of the print head, the ejected ink then travels through the ink aperture to exit the chamber and land on the substrate. In the first configuration, the ink aperture is open such that ink can travel out of the chamber. In the second configuration, the ink aperture is closed such that ink cannot travel out of the chamber, e.g. the chamber is sealed to the external atmosphere.

The self-cleaning operation may further comprise directing a cleaning fluid into the chamber to clean the chamber.

The chamber may be referred to as a cleaning chamber. The cleaning fluid may be solvent. The cleaning fluid may be a blend of solvents.

Directing the cleaning fluid into the chamber may comprise pumping cleaning fluid into the chamber (e.g. under a positive pressure).

Directing the cleaning fluid into the chamber may comprise sucking (e.g. drawing) cleaning fluid into the chamber, under a negative pressure. Cleaning fluid may subsequently be drawn out of the chamber, again under a negative pressure. Advantageously, a gutter pump can be used to draw the cleaning fluid in this manner. Drawing cleaning fluid under a negative pressure is advantageously failsafe insofar as if the sealing mechanism were to fail, no cleaning fluid would be drawn into the chamber owing to the negative pressure drawing in only air via the open sealing mechanism. Such an arrangement is therefore inherently failsafe in mitigating the risk that pressurised cleaning fluid be inadvertently ejected from the print head onto a printing line (e.g. products on a production line).

The method may further comprise draining used cleaning fluid from the chamber. Used cleaning fluid may be drained contemporaneously as (new/fresh) cleaning fluid is pumped into the chamber. That is to say, cleaning fluid may be actively pumped or drawn through the chamber. Alternatively, the cleaning fluid may occupy the chamber for a period of time before being subsequently drained (e.g. a dwell time, or dwell period, such as around 5 seconds). That is to say, cleaning fluid may reside in the chamber in a stagnant manner for a period of time. The cleaning fluid may therefore dwell in the cleaning chamber for a time. Cleaning fluid drained from the chamber may be stored in a separate fluid reservoir (e.g. separate to the mixer tank). The separate fluid reservoir may be selectively connectable to the mixer tank to maintain viscosity.

The cleaning fluid may be directed into the chamber from a solvent reservoir (e.g. a solvent tank). The solvent reservoir may contain solvent which has previously been used in an ink system. The cleaning fluid may be directed into the chamber from a solvent cartridge. The solvent cartridge may contain fresh, or virgin, solvent. A cleaning cycle may first be carried out using cleaning fluid from the solvent reservoir. The cleaning cycle may then be carried out using fresh cleaning fluid from the solvent cartridge. This may be described as pre-cleaning with dirty solvent, and finishing the cleaning cycle with a virgin solvent rinse. Cleaning the chamber may comprise agitating the cleaning fluid, in the chamber, by directing a flow of air through the chamber. This may be described as bubbling air through the chamber to agitate the cleaning fluid in the chamber.

Where the chamber is in fluid communication with a plurality of conduits, the conduits are preferably connected to the chamber at different locations. For example, a first conduit may be connected to an upstream end of the chamber (e.g. proximate the nozzle). For example, a second conduit may be connected to a downstream end of the chamber (e.g. proximate the gutter). Ports, to which the conduits are connected, are preferably provided at diametrically opposed locations with respect to one another in the chamber. For example, a first port may be disposed in a first corner of a cuboidal chamber, and the second port may be disposed at a diagonally opposed second corner of the cuboidal chamber.

The sealing mechanism may comprise a rotatable body rotatable about an axis of rotation between the first configuration and the second configuration, and wherein actuating the sealing mechanism of the self-cleaning print head from the first configuration to the second configuration comprises rotating the rotatable body of the sealing mechanism of the self-cleaning print head from the first configuration to the second configuration in which the chamber is sealed by the rotatable body.

The chamber may comprise a plurality of ports, and the method may further comprise selecting, by the continuous inkjet printer, a port of the chamber as a fill port, and a port of the chamber as a drain port, based upon the orientation of the self-cleaning print head, wherein directing the cleaning fluid into the chamber to clean the chamber comprises directing a flow of cleaning fluid through the fill port, into the cleaning chamber, to clean the cleaning chamber, and draining the cleaning fluid from the cleaning chamber, through the drain port, to drain the cleaning chamber.

The method may further comprise detecting, by continuous inkjet printer, the orientation of the self-cleaning print head using an orientation sensor.

The orientation sensor may be configured to output an orientation signal indicative of the orientation of the self-cleaning print head. On receiving the orientation signal indicative of the orientation of the self-cleaning print head, the continuous inkjet printer may output a valve control signal, to a plurality of valves, to control the flow of cleaning fluid into and/or out of the chamber based upon the orientation of the self-cleaning print head, wherein the plurality of valves are operable to control a flow of cleaning fluid flow into and/or out of the chamber.

The industrial printer may comprise a second marking head, and wherein when the first mentioned self-cleaning marking head is undergoing the self-cleaning operation, actuating the second marking head to mark one or more products.

In this way, when the self-cleaning marking head is being cleaned (and cannot mark products), the second marking head may be used instead. This allows cleaning of marking heads to take place without having to halt printing. For example, if the industrial printer is operating on a production line marking products traveling along the production line, cleaning of the self-cleaning marking head can take place without halting the production line as the second marking head can take the place of the (first) self-cleaning marking head.

Using the second marking head to mark one or more products may comprises initiating the second marking head to print on the one or more products in place of the first self-cleaning marking head.

The computer implemented method may further comprise determining, by the industrial printer, completion of the self-cleaning operation, and in response, actuating the first self-cleaning marking head to print on the one or more products in place of the second marking head.

That is, once cleaning is complete, the printer can switch back to using the first marking head in place of the second marking head. The second marking head may go into a dormant, or standby, state while not being used. The second marking head may of course be cleaned while not being used, such as when the first self-cleaning marking head is being used. Of course, the printer may instead continue to use the second marking head to print while the first self-cleaning marking head is in a standby state, the first self-cleaning marking head being used again when the second marking head requires cleaning. Detection that the second marking head requires cleaning may be the same as the detection that the first self-cleaning marking head requires cleaning.

The second marking head may be a second self-cleaning marking head.

The second self-cleaning marking head may be automatically cleaned when the printer has switched back to using the first self-cleaning marking head in place of the second marking head.

The computer implemented method may further comprise sending, by the industrial printer and in response to the determination of the service issue, data indicative of the service issue to an external controller, and receiving, by the industrial printer and from the external controller, a control signal, the control signal configured to cause the industrial printer to execute the cleaning operation, wherein executing, by the industrial printer, the cleaning operation in response to the service issue comprises executing, by the industrial printer, the cleaning operation in response to the control signal.

The external controller is external to the industrial printer, as described above. For example, the external controller could be a production line controller (e.g. a filling machine). The industrial printer may determine that there is a service issue, and in response send a message (the data indicative of the service issue) to an external controller to alert the external controller to the service issue. The external controller can then determine an appropriate time to send the control signal to the industrial printer to initiate cleaning. The external controller may have an overview of the running of a production line, and so can select an appropriate time to carry out cleaning, such as when the production line is halted. That is, the external controller may allow coordination of cleaning with production line downtime.

The computer implemented method may further comprise sending, by the external controller, the control signal to the industrial printer.

Sending, by the external controller, the control signal may comprise determining, by the external controller, that a predetermined condition is satisfied, and on the determination of the predetermined condition being satisfied sending the control signal.

The predetermined condition may be a predetermined time, such as a known time of production downtime on a production line.

The predetermined condition may be a status of a production line on which the industrial printer is operating.

The status may comprise a halt on the production line on which the industrial printer is operating.

For example, the external controller may determine that the production on the production line has been halted due to an unscheduled event, such as a failure of a component other than the industrial printer. In this way, the cleaning of the marking head can take place at times at which the production line is down, without having to unnecessarily halt the production line to clean the marking head.

The predetermined condition may comprise a predetermined time. For example, the production line may be scheduled to halt at the predetermined time in order to carry out maintenance, or change over of products to be marked. Therefore, the predetermined time may be a predetermined maintenance time or product change over time.

The computer implemented method may further comprise determining, by the industrial printer, completion of the self-cleaning operation, and sending, by the industrial printer, data indicating that the self-cleaning operation is complete to the external controller.

For example, the industrial printer may determine that the cleaning operation is complete and alert the external controller by sending a message (data indicating that the self-cleaning operation is complete) indicating that the industrial printer is ready to print again. The industrial printer may then receive a further control signal from the external controller, the further control signal causing the industrial printer to mark products with the first self-cleaning marking head.

In a third aspect, there is provided a computer implemented method for operating an industrial printer, the industrial printer comprising a first marking head and a second marking head, the industrial printer operating on a production line and marking products on the production line using the first marking head, the computer implemented method comprising, determining a service issue associated with the first marking head, performing, in response to determining the service issue, a cleaning operation on the first marking head, and actuating, in response to the performing, the second marking head to mark products on the production line in place of the first marking head.

In this way, when the first marking head is being cleaned (and cannot mark products), the second marking head may be used instead in place of the first marking head. This allows cleaning of marking heads to take place without having to halt printing.

The logic associated with each step may take place at any suitable processor. For example, the determination of the service issue associated with the first marking head may be made by a processor of either the industrial printer or an external controller. The service issue may be determined based on recorded sensor data from one or more sensors associated with the printer and/or first marking head.

The first and/or second marking head may be a self-cleaning marking head, and the cleaning operation may be a self-cleaning operation.

The self-cleaning operation may be a self-cleaning operation as disclosed herein.

The industrial printer may be a continuous inkjet printer and the first and second self-cleaning marking heads may be first and second self-cleaning print heads.

The self-cleaning operation may comprise actuating a sealing mechanism of the first self-cleaning print head from a first configuration, in which a chamber of the first self-cleaning print head is in communication with atmosphere via at least an ink aperture, to a second configuration in which the chamber is sealed.

Sealing is intended to encompass the chamber being in fluid communication with one or more conduits, preferably a plurality of conduits. At least one conduit may be for supplying the chamber with cleaning fluid. At least one conduit may be for draining used/spent/dirty cleaning fluid from the chamber. Each of the conduits is preferably closeable under action of a respective valve. Each of the conduits is preferably bidirectional insofar as the conduit can either supply cleaning fluid, or drain used cleaning fluid, depending upon the configuration.

Advantageously, the chamber is sealed and can be cleaned in an automated manner, along with any components disposed within the chamber (e.g. deflection electrode).

The chamber may comprise one or more ports. A port may be considered to be an opening in the surface of the chamber. One or more of the ports may couple to one or more of the conduits.

The first self-cleaning print head may comprise a nozzle for generating and ejecting a stream of ink droplets for printing, at least one electrode for guiding the stream of ink droplets, and a gutter for receiving droplets of ink which are not used for printing. The at least one electrode may be disposed in the chamber.

The ink aperture may form part of an ink channel, such as an ink slot. It is through the ink aperture that deflected ink, in operation, is ejected from the print head onto a substrate (e.g. an external substrate, such as a surface of a product to be marked). That is, once ink has been ejected from a nozzle of the print head, the ejected ink then travels through the ink aperture to exit the chamber and land on the substrate. In the first configuration, the ink aperture is open such that ink can travel out of the chamber. In the second configuration, the ink aperture is closed such that ink cannot travel out of the chamber, e.g. the chamber is sealed to the external atmosphere.

The self-cleaning operation may further comprise directing a cleaning fluid into the chamber to clean the chamber.

The chamber may be referred to as a cleaning chamber. The cleaning fluid may be solvent. The cleaning fluid may be a blend of solvents.

Directing the cleaning fluid into the chamber may comprise pumping cleaning fluid into the chamber (e.g. under a positive pressure).

Directing the cleaning fluid into the chamber may comprise sucking (e.g. drawing) cleaning fluid into the chamber, under a negative pressure. Cleaning fluid may subsequently be drawn out of the chamber, again under a negative pressure. Advantageously, a gutter pump can be used to draw the cleaning fluid in this manner. Drawing cleaning fluid under a negative pressure is advantageously failsafe insofar as if the sealing mechanism were to fail, no cleaning fluid would be drawn into the chamber owing to the negative pressure drawing in only air via the open sealing mechanism. Such an arrangement is therefore inherently failsafe in mitigating the risk that pressurised cleaning fluid be inadvertently ejected from the print head onto a printing line (e.g. products on a production line).

The method may further comprise draining used cleaning fluid from the chamber. Used cleaning fluid may be drained contemporaneously as (new/fresh) cleaning fluid is pumped into the chamber. That is to say, cleaning fluid may be actively pumped or drawn through the chamber. Alternatively, the cleaning fluid may occupy the chamber for a period of time before being subsequently drained (e.g. a dwell time, or dwell period, such as around 5 seconds). That is to say, cleaning fluid may reside in the chamber in a stagnant manner for a period of time. The cleaning fluid may therefore dwell in the cleaning chamber for a time. Cleaning fluid drained from the chamber may be stored in a separate fluid reservoir (e.g. separate to the mixer tank). The separate fluid reservoir may be selectively connectable to the mixer tank to maintain viscosity.

The cleaning fluid may be directed into the chamber from a solvent reservoir (e.g. a solvent tank). The solvent reservoir may contain solvent which has previously been used in an ink system. The cleaning fluid may be directed into the chamber from a solvent cartridge. The solvent cartridge may contain fresh, or virgin, solvent. A cleaning cycle may first be carried out using cleaning fluid from the solvent reservoir. The cleaning cycle may then be carried out using fresh cleaning fluid from the solvent cartridge. This may be described as pre-cleaning with dirty solvent, and finishing the cleaning cycle with a virgin solvent rinse. Cleaning the chamber may comprise agitating the cleaning fluid, in the chamber, by directing a flow of air through the chamber. This may be described as bubbling air through the chamber to agitate the cleaning fluid in the chamber.

Where the chamber is in fluid communication with a plurality of conduits, the conduits are preferably connected to the chamber at different locations. For example, a first conduit may be connected to an upstream end of the chamber (e.g. proximate the nozzle). For example, a second conduit may be connected to a downstream end of the chamber (e.g. proximate the gutter). Ports, to which the conduits are connected, are preferably provided at diametrically opposed locations with respect to one another in the chamber. For example, a first port may be disposed in a first corner of a cuboidal chamber, and the second port may be disposed at a diagonally opposed second corner of the cuboidal chamber.

The sealing mechanism may comprise a rotatable body rotatable about an axis of rotation between the first configuration and the second configuration, and wherein actuating the sealing mechanism of the first self-cleaning print head from the first configuration to the second configuration comprises rotating the rotatable body of the sealing mechanism of the first self-cleaning print head from the first configuration to the second configuration in which the chamber is sealed by the rotatable body.

The chamber may comprise a plurality of ports, and the method may further comprise selecting, by the continuous inkjet printer, a port of the chamber as a fill port, and a port of the chamber as a drain port, based upon the orientation of the first self-cleaning print head, wherein directing the cleaning fluid into the chamber to clean the chamber comprises directing a flow of cleaning fluid through the fill port, into the cleaning chamber, to clean the cleaning chamber, and draining the cleaning fluid from the cleaning chamber, through the drain port, to drain the cleaning chamber.

The method may further comprise detecting, by continuous inkjet printer, the orientation of the first self-cleaning print head using an orientation sensor.

The orientation sensor may be configured to output an orientation signal indicative of the orientation of the first self-cleaning print head. On receiving the orientation signal indicative of the orientation of the self-cleaning print head, the continuous inkjet printer may output a valve control signal, to a plurality of valves, to control the flow of cleaning fluid into and/or out of the chamber based upon the orientation of the first self-cleaning print head, wherein the plurality of valves are operable to control a flow of cleaning fluid flow into and/or out of the chamber.

When the first marking head is being used to mark products, the second marking head may not be being used to mark products.

For example, the second marking head may be considered a spare marking head that is not used during normal usage, and only used when the first marking head is being cleaned (or otherwise out of action).

In a fourth aspect there is provided a computer implemented method for cleaning a self-cleaning marking head of an industrial printer, the method comprising determining, by the industrial printer, a condition has been met, and executing, by the industrial printer, a self-cleaning operation of the self-cleaning marking head in response to the determination that the condition has been met.

The condition may be a scheduled time (or time period). For example, the scheduled time may be a predetermined time known to the industrial printer by which the printer should carry out a self cleaning operation of the marking head.

The condition may be a determination that no products have passed by the industrial printer for a predetermined period of time. For example, the industrial printer may have sensors (or access to data from external sensors), that detect the passing of products as they travel along a conveyor. If no products have passed by the industrial printer in the predetermined period of time, it may be assumed that the production line is idle and a self-cleaning operation of the self-cleaning marking head can be performed without holding up the production line. Sensor data may be combined with temporal data. For example, the condition may be both a determination that no products have passed by the industrial printer for a predetermined period of time and a determination that the present time corresponds to the scheduled time described above.

The condition may comprise historical data. For example, the historical data may comprise an elapsed time and/or number of prints since a last failure event. For example, if it is determined that there has been an elapsed time and/or number of prints since a last failure event, the industrial printer may determine that the condition has been met.

The historical data may comprise data indicating the average time between failures. For example, if it is determined that the industrial printer is approaching, or has reached, the average time before failure, the industrial printer may determine that the condition has been met.

The historical data may comprise data indicating marking medium (e.g. ink) usage. For example, if a predetermined amount of marking medium has been used, the industrial printer may determine that the condition has been met.

The historical data may comprise data indicating the mark being applied to the product and/or a number of individual marking actions (e.g. number of printed drops in the case of a continuous ink jet printer). For example, if a predetermined number of marks have been applied, or a predetermined number of individual marking actions has occurred, the industrial printer may determine that the condition has been met.

The historical data may comprise data indicating historical environmental data, such as the ambient humidity, temperature, and/or pressure in the environment in which the industrial printer is operating. The environmental data may be collected over a predetermined period in which the industrial printer has been operating in. If the environmental data meets a predetermined condition, such as one or more of the humidity, temperature and/or pressure being above (or below) a certain level for certain period of time, the industrial printer may determine that the condition has been met. The method may further comprise obtaining, by the industrial printer, sensor data indicative of an operation of the self-cleaning marking head, wherein determining, by the industrial printer, that the condition has been met comprises determining a service issue associated with the self-cleaning marking head based on the sensor data.

In a fifth aspect there is provided a system comprising an industrial printer, an external controller coupled to the industrial printer and wherein the system is configured to carry out the method of the first, second, third and fourth aspect.

The industrial printer may comprise one or more processors and a computer readable medium storing thereon computer readable instructions, which when executed by the one or more processors, cause the one or more processors to carry out the methods disclosed hereon according to the first, second or third aspects. For example, the instructions may cause the one or more processors to receive from an external controller the control signal described above, and to cause the one or more processors to execute the self-cleaning operation as described above.

The external controller may comprise one or more processors and a computer readable medium storing thereon computer readable instructions, which when executed by the one or more processors, cause the one or more processors to carry out the methods disclosed hereon according to the first, second or third aspects. For example, the instructions may cause the one or more processors to send the control signal as described with respect to any of the first, second and third aspects.

The external controller may be coupled to the industrial printer using any suitable means, wired or wireless, that facilitates the transmission of data.

In a sixth aspect there is provided a computer readable medium storing computer readable instructions, which when executed by one or more processors cause the one or more processors to carry out the method of any one of the first, second, third or fourth aspects.

It will be appreciated that optional features of one aspect may be combined with feature from another aspect. It will also be appreciated that where it is stated that a particular apparatus, such as the industrial printer or external controller, carries out a particular function, it may be that the apparatus uses its processor to carry out the function.

Specific embodiments of the present disclosure will now be described, by way of example only, with reference to the accompanying drawings in which:

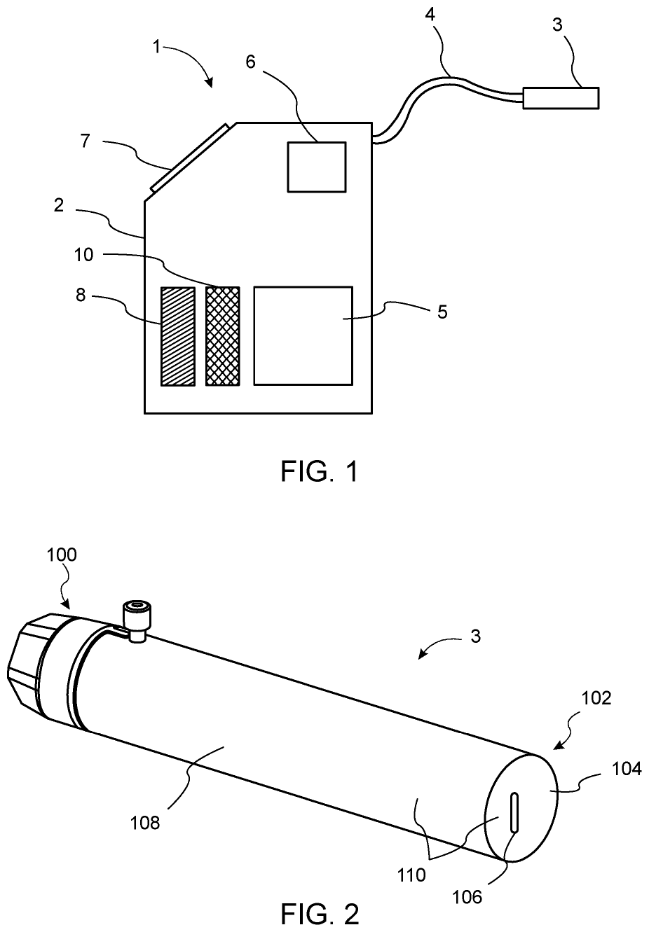

FIG. 1 is a schematic illustration of a continuous inkjet (CIJ);

FIG. 2 is a perspective view of a print head, of the printer shown in FIG. 1, in isolation;

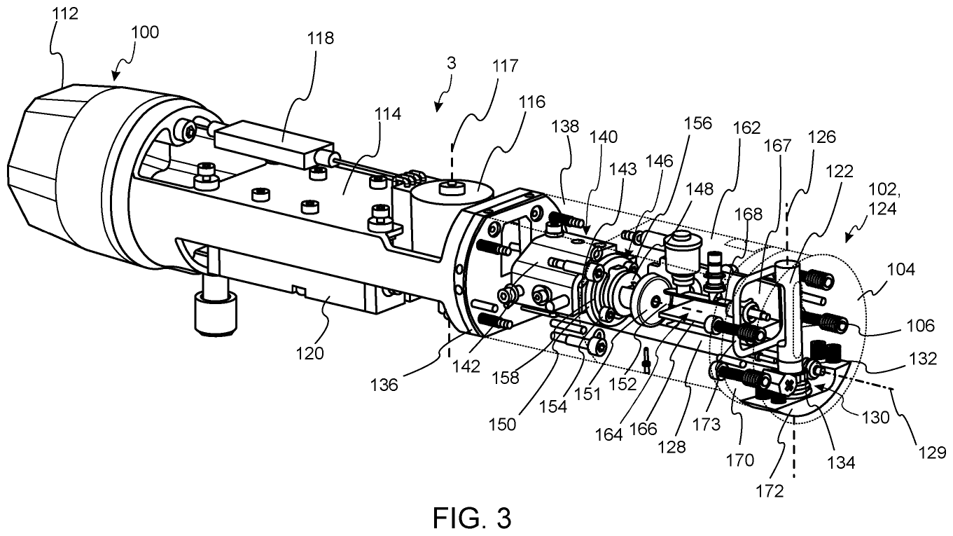

FIG. 3 is an alternative perspective view of the print head of FIG. 2 with an outer casing omitted;

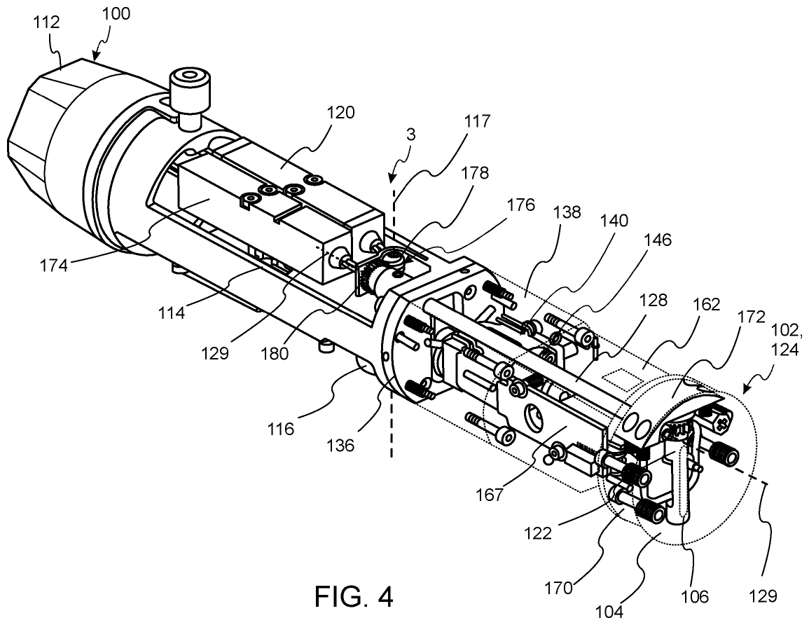

FIG. 4 is an alternative perspective view of the print head of FIG. 3;

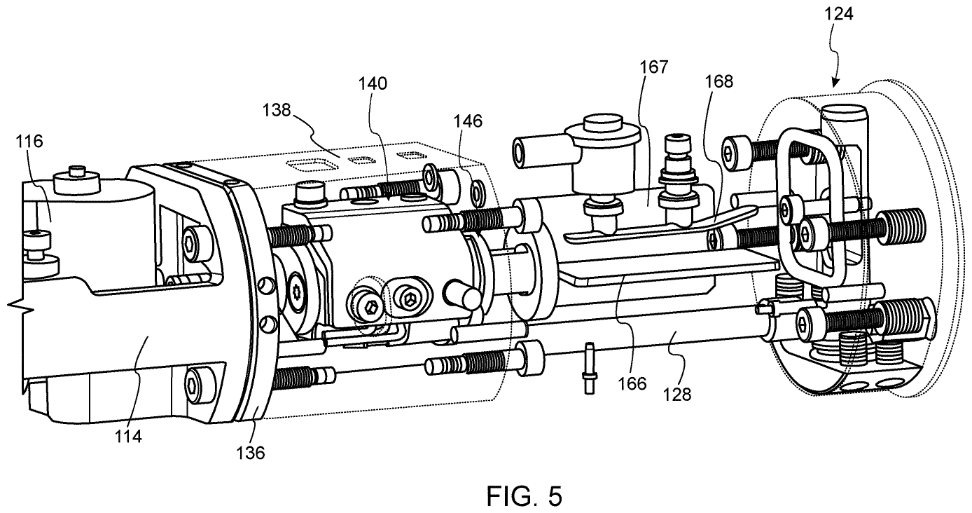

FIG. 5 is a magnified view of part of the print head shown in FIGS. 4 and 5 with a chamber housing omitted;

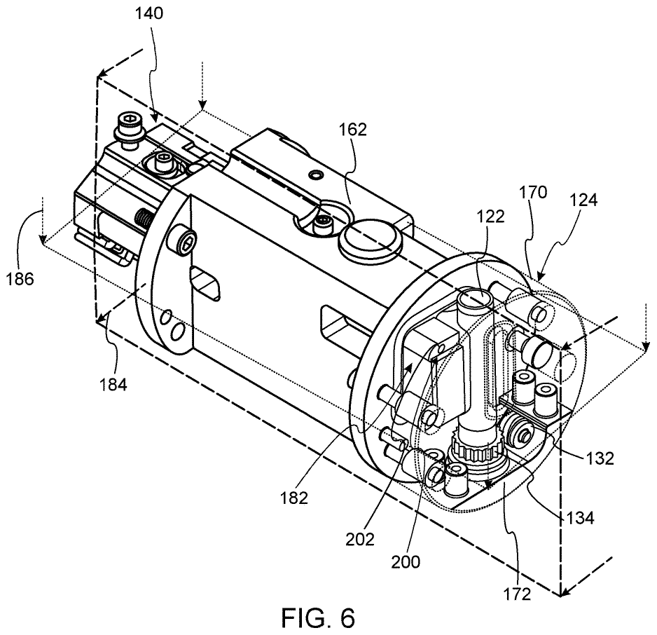

FIG. 6 is a perspective view of a subassembly of the print head of FIGS. 2 to 5;

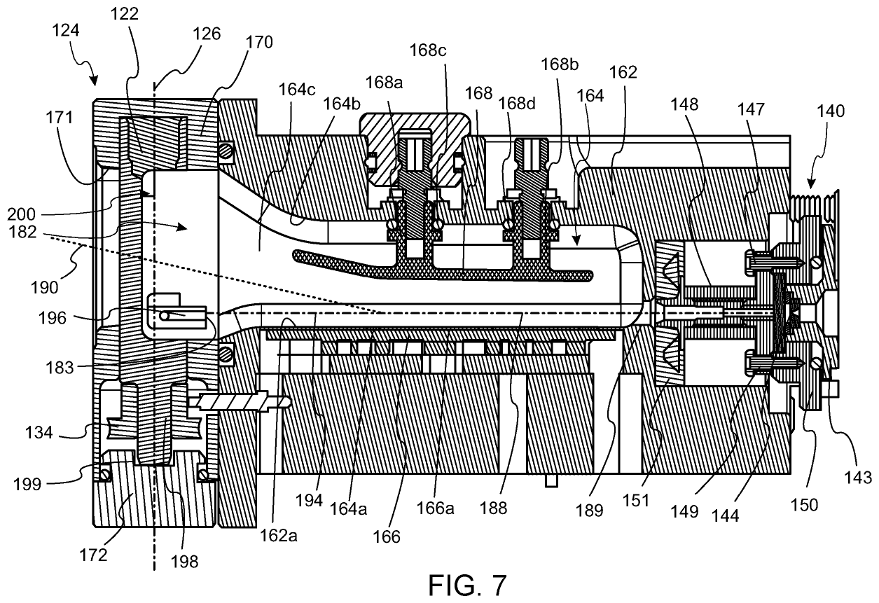

FIG. 7 is a cross-section side view of the subassembly of FIG. 6;

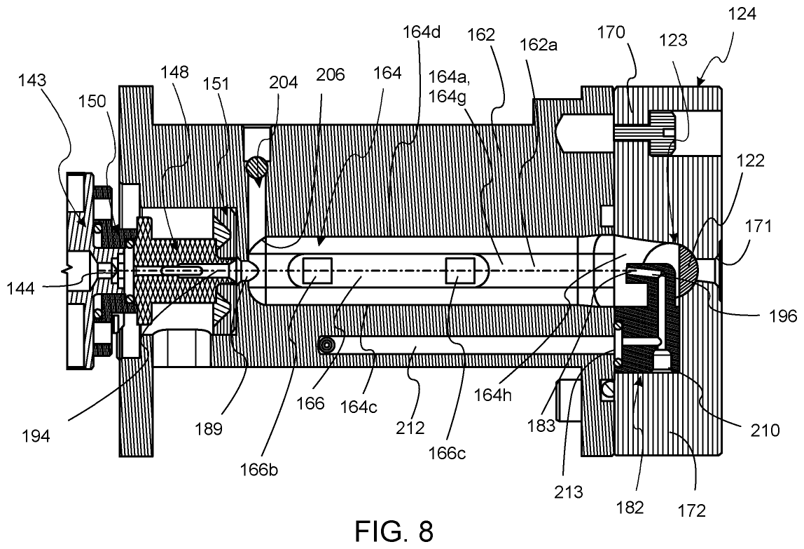

FIG. 8 is an alternative cross-section view of the subassembly of FIGS. 6 and 7;

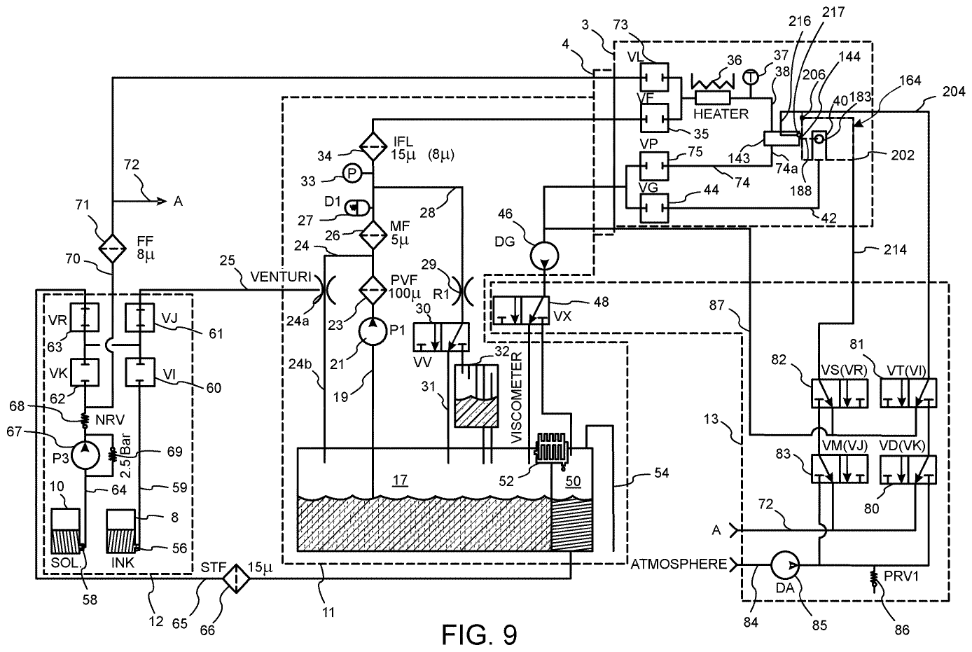

FIG. 9 is a simplified schematic diagram of a fluid system for the printer of FIG. 1; incorporating the print head shown in FIGS. 2 to 7;

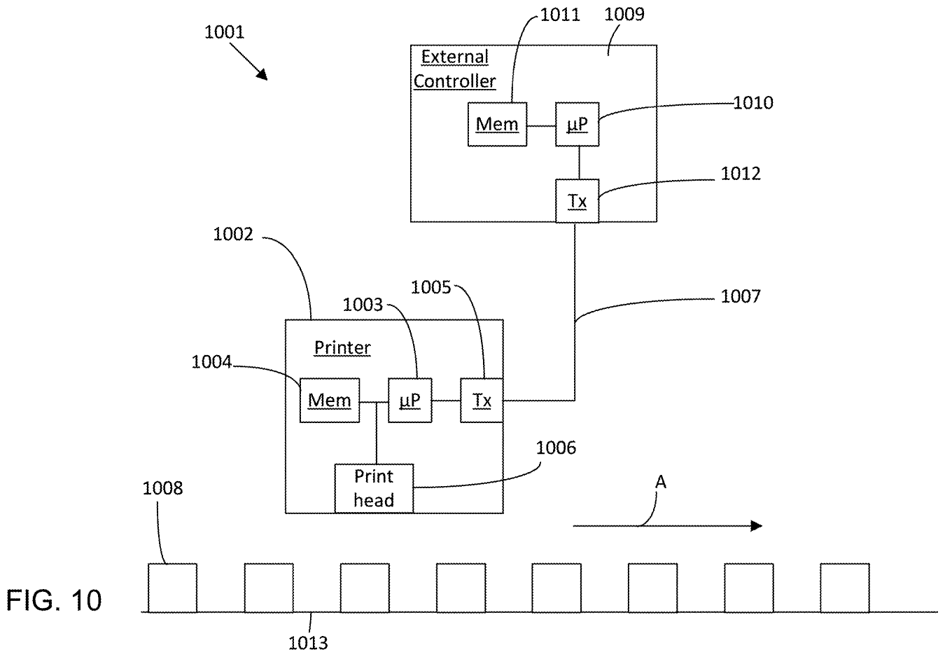

FIG. 10 shows a schematic of a production line on which a continuous inkjet printer is operating;

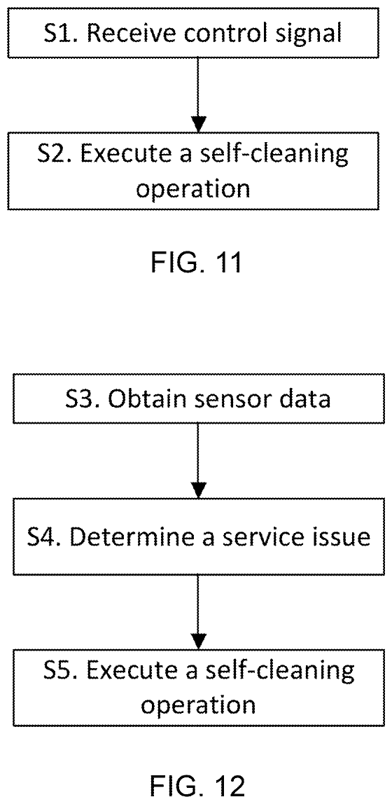

FIG. 11 shows a flow chart according to a method of cleaning a self cleaning print head;

FIG. 12 shows a flow chart according to another method of cleaning a self cleaning print head; and

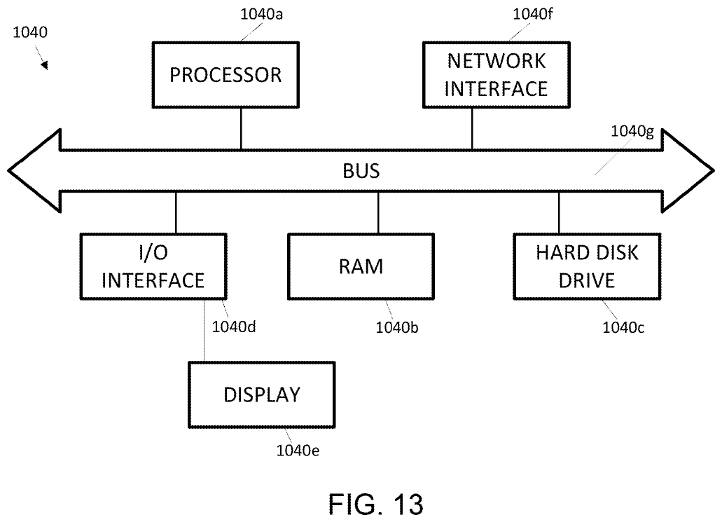

FIG. 13 shows an example computing apparatus on which the methods disclosed herein may be performed.

FIG. 1 schematically illustrates a continuous inkjet (CIJ) printer 1. The printer 1 comprises a printer body 2 (which may be referred to as a cabinet) connected to a print head 3 by an umbilical cable 4. The printer body 2 houses an ink system 5 and a printer controller 6. The printer body 2 also has an interface 7 (e.g. a display, keypad, and/or touch screen) for use by an operator.

The print head 3 is arranged to print on a substrate provided adjacent to the print head 3. The printer 1 typically comprises two cartridge connections for engagement with respective fluid cartridges. In particular, the printer 1 comprises an ink cartridge connection for engagement with an ink cartridge 8 and a (separate) solvent cartridge connection for engagement with a solvent cartridge 10. The cartridge connections typically each comprise a fluid port arranged to connect to a fluid pathway within the printer 1 to allow fluid to flow between the cartridges 8, 10 and other parts of the inkjet printer 1, such as the ink system 5 and the print head 3 (via the umbilical 4).

In operation, ink from the ink cartridge 8 and solvent from the solvent cartridge 10 can be mixed within the ink system 5 to generate printing ink of a desired viscosity that is suitable for use in printing. This ink is supplied to the print head 3 and unused ink is returned from the print head 3 to the ink system 5 (via the umbilical 4). When unused ink is returned to the ink system 5 from the print head 3, air may be drawn in with ink from a gutter of the print head 3. The air may then become saturated with solvent in the gutter line.

In operation, ink is delivered under pressure from the ink system 5 to the print head 3 and recycled back via flexible tubes which are bundled together with other fluid tubes and electrical wires (not shown) into the umbilical cable 4. In order to maintain correct consistency of the ink, the ink system 5 may be operable to mix ink removed from the cartridge 8 with solvent removed from the cartridge 10 and to mix them together to obtain an ink having the correct viscosity and/or density for a particular printing application.

Of particular relevance to the present application, the print head 3 is a self-cleaning print head. Without operator intervention, the print head 3 can be sealed, and a cleaning fluid be flushed through at least part of the print head 3, in order to clean the print head 3. As will be set out in the following description and accompanying figures, this is achieved by incorporation of a sealing mechanism, comprising a rotatable body, in the print head 3.

Turning to FIG. 2, a perspective view of the print head 3 in isolation is provided.

The print head 3 comprises a first end 100 by which the print head 3 is connectable to an umbilical 4 as shown in FIG. 1. The first end 100 may therefore comprise a connector (e.g. a threaded connector in the illustrated embodiment). At an opposing end, the print head 3 comprises a second end 102. Provided at the second end 102 is an end cap 104. The end cap 104 defines an outermost part of the print head 3. The end cap 104 comprises an ink aperture 106, which may be referred to as an ink slot. It is through the ink aperture 106 that deflected ink, in operation, is ejected from the print head 3 onto a substrate (e.g. an external substrate which moves past the print head 3). Extending generally between the first and second ends 100, 102 is an outer shell 108. The outer shell 108 is generally cylindrical in the illustrated embodiment and provides a protective cover for the components which make up the print head 3. In order to expose the components, such as for maintenance, the outer shell 108 is removable. The combination of the end cap 104 and the outer shell 108 may be described as an outer cover 110 of the print head 3.

When the print head 3 is to be cleaned (e.g. by way of the self-cleaning capability of the print head 3), the ink aperture 106 can effectively be closed, and sealed, by a sealing mechanism within the print head 3. That is to say, when cleaning fluid is flushed through a chamber of the print head 3 (which will be described below), cleaning fluid cannot escape from the print head 3 through the ink aperture 106. For the purposes of this application, the closing of the ink aperture 106 may not infer a change in the geometry of the ink aperture 106 geometry itself. That is to say, the ink aperture 106 remains as shown in FIG. 2 regardless of whether it is opened or closed (by operation of the sealing mechanism). However, at least in the illustrated embodiment, the ink aperture 106 can be obscured (e.g. covered, internally) by an upstream rotatable body to define the sealed chamber. This will be described in detail later in this document.

Turning to FIG. 3, a perspective view of the print head 3 is provided with the outer shell 108 omitted. Various components which make up the print head 3 are therefore visible, and a number of components are also shown in a partially cutaway view to improve visibility.

FIG. 3 shows a connector 112, by which the print head 3 is connectable to an umbilical, provided at the first end 100 of the print head. The connector 112 is integral with a chassis 114. The chassis 114 defines a platform of sorts to which various other components are mounted. For example, a motor 116 and high voltage resistor 118 are mounted to the chassis 114 in the illustrated embodiment. The high voltage resistor 118 limits the current and spark energy available to the electrodes (described below). In other embodiments the high voltage resistor 118 may be mounted closer to a deflection electrode 168 to reduce a cable length therebetween. The high voltage resistor 118 may therefore be mounted to a chamber housing 162 or PCB 167, for example. A solenoid valve 120 is also mounted to the chassis 114. In the illustrated embodiment the solenoid valve 120 is mounted to the chassis 114 via a valve manifold. The motor 116 is a stepper motor in the illustrated embodiment, but other varieties of motor may otherwise be used (e.g. a brushless DC motor, a linear motor, a solenoid or other suitable actuator).

A shaft of the motor 116 rotates about an axis of rotation 117, which may be referred to as a motor axis. The motor 116 is provided in power communication with a rotatable body 122 which forms part of a sealing mechanism 124. The sealing mechanism 124 is located at the second end 102 of the print head 3 and, as mentioned above, is a particular focus of the present application. Briefly, the rotatable body 122 is rotatable about an axis of rotation 126. The rotatable body 122 is rotatable between a first configuration, in which an ink path is defined across the rotatable body 122 and through the ink aperture 106, and a second configuration (as shown in FIG. 3) in which the rotatable body 122 closes the ink aperture 106. In the second configuration the sealing mechanism 124, specifically the rotatable body 122 thereof, seals part of the print head 3 (i.e. a chamber) to allow that part to be flushed with cleaning fluid to clean the print head 3.

As previously mentioned, the motor 116 is in power communication with the rotatable body 122 to drive rotation of the rotatable body 122. The motor 116 is in power communication with the rotatable body 122 via a shaft 128. The shaft 128 is disposed outside of a chamber which is selectively sealed by the rotatable body 122 (e.g. see chamber 164 in FIG. 7). The shaft 128 extends along an extent of the chamber. The shaft 128 is in power communication with the rotatable body 122 via a worm gear 130 comprising a worm 132 and a gear 134. The worm 132 is coupled to an end of the shaft 128 (e.g. which is proximate the second end 102 of the print head 3). The gear 134 is rotatably coupled to the rotatable body 122. The worm gear 130 changes the direction of rotation of the shaft 128 from the axis of rotation 129 to the axis of rotation 126. Although not visible in FIG. 3 a further worm gear is used to change a direction of rotation of the motor 116 at an obscured end of the shaft 128 (e.g. located towards the first end 100 of the print head 3). As mentioned above, the shaft 128 rotates about the axis of rotation 129. The axis of rotation 129 extends in a longitudinal direction along the print head 3, and the print head 3 may be described as generally extending in the same longitudinal direction.

The use of the drive assembly including the shaft 128 and the worm gear 130 is advantageous for a number of reasons. Firstly, incorporation of the shaft 128 means that the motor 116 can be disposed in a different part of the print head 3 to that of the rest of sealing mechanism 124. This is desirable for reasons of not increasing the longitudinal extent of the print head 3 at the second end 102 by any more than is needed (e.g. to accommodate the volume of the motor). Increasing the longitudinal extent of the print head 3 at the second end 102 risks reducing a throw distance by which the print head 3 must be offset from a substrate to be printed. The use of the worm gear 130 is also advantageous for at least the reason that the gearing can effectively increase the torque output transmitted by the motor 116 to the rotatable body 122. This is particularly desirable where the rotatable body 122 may be partially stuck in position (e.g. stiction) following a cleaning process and a subsequent drying process. Described another way, the use of the worm gear 130 reduces the risk that the rotatable body 122 is stuck in position such that the drive assembly is unable to rotate the rotatable body 122 about the axis of rotation 126.

Returning to describe other components of the print head 3, coupled to the chassis 114 is a manifold 136. Various fluid and electrical connections extend through the manifold 136.

A nozzle housing 138 (shown in a partially cutaway view in FIG. 3) is coupled to the manifold 136 and houses a nozzle assembly 140. The nozzle housing 138 may otherwise be described as a body forming part of a housing. The nozzle assembly 140 comprises, among other components, a nozzle cradle 142 and a nozzle body 143. The nozzle body 143 defines a nozzle (not visible in FIG. 3) for generating and ejecting a stream of ink droplets for printing.

A charge electrode assembly 146 is coupled to the nozzle assembly 140. The charge electrode assembly 146 comprises a charge electrode 148 and an insulating coupling 150 to which the charge electrode 148 is coupled. As a stream of ink droplets is directed past the charge electrode 148 in use, they are selectively and separately given a predetermined level of charge by the charge electrode 148. In order to aid the alignment of the charge electrode 148 with respect to the stream of droplets emanating from the nozzle of the nozzle body 143, the charge electrode 148 is rotatably adjustable about axis. As will be appreciated from FIG. 3, the boot 151 is sandwiched between the charge electrode 148 and a chamber housing 162. The boot 151 allows the charge electrode 148 to remain sealingly engaged with the chamber housing 162 (see also FIGS. 7/8) whilst the charge electrode 148 is adjusted.

Returning to FIG. 3, coupled to the nozzle housing 138 is a chamber housing 162 (also shown partially cutaway in FIG. 3). The chamber housing 162 defines a chamber 164. The chamber 164 may otherwise be described as a washing cavity. Although further information in connection with the chamber 164 will be provided in the following Figures (the chamber 164 being visible in FIGS. 7 and 8 in particular), when the rotatable body 122 is in a second configuration in which the ink aperture 106 is closed, the chamber 164 is sealed for cleaning. Directing, or flushing a cleaning fluid into and through the chamber 164 when sealed thus cleans the chamber 164 and the associated components of the print head 3 which are provided in the chamber 164. Directing a cleaning fluid into the chamber 164 may comprise pumping the cleaning fluid (e.g. by action of an upstream pump, and under a positive pressure) and/or drawing the cleaning fluid (e.g. by action of a downstream pump, and under a negative pressure).

Coupled to the chamber housing 162, and mounted within the chamber 164, is a low voltage (e.g. grounded, or negative potential) electrode 166 and a deflection (e.g. high voltage) electrode 168. The electrodes 166, 168 may collectively be referred to as a pair of deflection electrodes. The low voltage electrode 166 may further comprise a phase detector which detects the phase of the charged particles in operation. The low voltage electrode 166 may be coupled to the chamber housing 162 by adhesive. In other embodiments the low voltage electrode 166 may be coupled to the chamber housing 162 by a gasket. The deflection electrode 168 is for guiding the stream of ink droplets, which are ejected by the nozzle and charged by the charge electrode 148, away from a gutter and towards the ink aperture 106 for printing onto a substrate in use. The deflection electrode 168 is disposed within the chamber 164 and can therefore be cleaned when the chamber 164 is sealed and the cleaning process is carried out.

The print head 3 further comprises a casing 170. The casing 170 forms part of the sealing mechanism 124. The casing 170 is coupled to the chamber housing 162. The casing 170 sealingly engages the chamber housing 162 by way of a gasket 173 which interposes the chamber housing 162 and the casing 170. The casing 170 may otherwise be described as a rotatable body mount, or housing. As will be described in detail later in this document, the rotatable body 122 is rotatably mounted within the casing 170 to selectively open and close the ink aperture 106. The casing 170 further comprises a cap 172 which is selectively detachable from the rest of the casing 170 to aid the installation and maintenance of the moving parts of the sealing mechanism 124 (e.g. the rotatable body 122). The casing 170 further comprises the end cap 104, which defines the ink aperture 106. The casing 170 may therefore be said to define the ink aperture 106. Although the ink aperture 106 is specifically defined by end cap 104 in the illustrated embodiment, in other embodiments the end cap 104 may be omitted. The casing 170 may therefore define the ink aperture even in the absence of an end cap. Also of note, the ink aperture 106 is downstream of the rotatable body 122 in the illustrated embodiment. That is to say, a stream of ink droplets first passes across the rotatable body 122 and then passes through the ink aperture 106. In other embodiments the rotatable body may define a downstream-most point of the ink path, such that there is no end cap positioned downstream of the rotatable body. In such embodiments the surrounding casing may be considered to define an ink aperture across the rotatable body.

For the avoidance of doubt, in the illustrated embodiment the end cap 104 is coupled to the chamber housing 162 and does not move in operation. That is to say, the end cap 104 is fixed in position. However, in other embodiments the end cap may define at least part of the rotatable body of the sealing mechanism. For example, the end cap may rotate, about an axis generally parallel to axis 129. The rotational position of the end cap may determine an extent to which an ink aperture of the end cap overlaps an ink aperture of an adjacent casing to ‘open’ the ink aperture of the adjacent casing. Where the ink apertures overlap at least partly, or entirely, the rotatable body (e.g. end cap) may be said to be in a first configuration in which an ink path is defined across the end cap. Where the ink aperture of the end cap does not overlap the ink aperture of the adjacent casing, the rotatable body (e.g. end cap) may said to be in a second configuration in which the ink aperture of the casing is closed.

Although shown in FIG. 3, various fasteners used to couple the chassis 114, the manifold 136, the nozzle housing 138, the chamber housing 162 and the casing 170 together are not annotated or described here in detail for brevity.

As will be appreciated from FIG. 7, the chamber 164 is defined by a combination of the chamber housing 162 and the casing 170. The chamber 164 has a lower surface defined by a combination of the low voltage electrode 166 (e.g. by surface 166a) and the surrounding chamber housing 162 (e.g. surface 162a), an upper surface which extends above the deflection electrode 168 (i.e. such that the deflection electrode 168 is disposed in the chamber 164) and is at least wide enough to contain the deflection electrode 168. Third and fourth surfaces 164c, 164d (which may be referred to as side surfaces) of the chamber 164 extend between the first and second surfaces 164a, 164b to define a perimeter of the chamber 164. The fourth surface 164d is not visible in FIG. 7.

With reference to FIG. 3, the print head 3 further comprises a PCB 167 which is mounted within the chamber housing 164. However, as indicated in FIG. 7, the PCB is not disposed within the chamber 164.

Turning to FIG. 4, an alternative perspective view of the print head 3 is provided. Owing to the different perspective, a number of components not visible, or only partially visible, in FIG. 3 are visible in FIG. 4.

Beginning from the first end 100 of the print head 3, the connector 112 and integral chassis 114 are shown. The solenoid valve 120 is shown mounted to the chassis 114, along with a valve block 174. Also visible in FIG. 4 is a worm gear 176 comprising a worm 178 and a gear 180. The worm 178 is rotatably coupled to the motor 116 which is just visible at the opposing side of the chassis 114 as shown in FIG. 4 (and is more clearly visible in FIG. 3). The worm 178 is driven to rotate about the axis of rotation 117. The worm 178 is provided in driving communication with the gear 180, the gear 180 being rotatably coupled to the shaft 128. The gear 180 and shaft 128 are thus driven to rotate about the axis of rotation 129, which may be referred to as a shaft axis. It will be appreciated that by use of the worm gear 176, the direction of rotation as driven by the motor 116 is effectively translated through 90° which is advantageous for reasons of space constraints within the print head 3. The shaft 128 is shown extending across an entire extent of each of the manifold 136, nozzle housing 138, chamber housing 162 and partially through the casing 170.

As described in connection with FIG. 3, also coupled to the chassis 114 are manifold 136, nozzle housing 138, chamber housing 162 and casing 170. The PCB 167 is also visible in FIG. 4. The nozzle assembly 140, coupled to the nozzle housing 138, and the charge electrode assembly 146 are also partially visible in FIG. 4.

Turning briefly to the sealing mechanism 124 at the second end 102 of the print head 3, as previously described the sealing mechanism 124 comprises the casing 170 (which comprises cap 172 and end cap 104) and the rotatable body 122. The ink aperture 106, defined by the casing 170, is also visible.

Of note, a component that has not yet been described in detail in connection with the print head 3 is that of a gutter. The print head 3 does incorporate a gutter which, in the illustrated embodiment, is a fixed gutter coupled to the casing 170. Details of the gutter will be provided in connection with FIG. 6 onwards.

Turning to FIG. 5, a magnified perspective view of part of the print head 3 is provided. As will be appreciated from FIG. 5, the motor 116 is partially visible, as is the chassis 114, but any components further towards the first/connector end of the print head 3 are not visible. Similarly, the chamber housing 162 as shown in FIGS. 3 and 4 is not shown in FIG. 5 to aid visibility of the components housed therein.

FIG. 5 shows the geometry of the deflection electrode 168 which is used to guide a stream of ink droplets towards a substrate to be printed.

FIG. 6 is a perspective view of a subassembly of the print head 3. FIG. 6 shows the chamber housing 162 with the nozzle assembly 140 and sealing mechanism 124 coupled thereto.

As previously described, various components of the sealing mechanism 124 are visible including the rotatable body 122, the casing 170, including the cap 172, and the worm 132 and gear 134. Also visible in FIG. 6 is gutter block 182. The gutter block 182 will be described in greater detail in connection with later Figures, but briefly the gutter block 182 comprises a gutter aperture (not visible in FIG. 6) through which droplets of ink which are not used for printing are received and subsequently recirculated back to a mixer tank of the ink system (as will be described in detail in connection with FIG. 9). In the illustrated embodiment the gutter block 182 is a separate component to that of the surrounding casing 170 and other components. However, in some embodiments the gutter may be integral with the rotatable body (e.g. see FIGS. 17, 18).

The gutter block 182 further comprises a recess 200 defined in an effective underside of the gutter block 182. The recess 200 leads into a port 202. The port 202, in turn, defines a second conduit (e.g. 214 as shown in FIG. 9). Owing to the presence of the recess 200, the second conduit is still provided in fluid communication with the chamber even when the rotatable body 122 is in the second, closed configuration as shown in FIG. 6. Cleaning fluid can therefore be pumped or drawn into the chamber via the second conduit, or used (e.g. dirty) cleaning fluid be pumped or drawn out of the chamber via the second conduit. Further detail in this regard will be provided below.

Also schematically indicated on FIG. 6 are first and second cross-sectional markers 184, 186. 184 is a vertical cross-section and 186 is a horizontal cross-section. The markers 184, 186 correspond to the cross-section views provided in FIGS. 7 and 8 respectively.

Turning to FIG. 7, a cross-section side view of the subassembly shown in FIG. 6 is provided as indicated by annotation 184 in FIG. 6. FIG. 7 shows the chamber 164 which can be selectively sealed by the sealing mechanism 124.

Beginning from the right hand end of FIG. 7, only part of the nozzle body 143 of the nozzle assembly 140 is visible. Nozzle body 143 retains a nozzle 144 that generates and ejects a stream of ink droplets 188 for printing. Downstream of the nozzle 144 is the charge electrode 148. The charge electrode 148 is coupled to the insulating coupling 150. In the illustrated embodiment the charge electrode 148 is rotatably coupled to the insulating coupling 150 by fasteners 147, 149. The insulating coupling 150 (and so the charge electrode 148) is rotatably adjustable with respect to the nozzle body 143. The insulating coupling 150 is a insulator (which may be plastic) which separates the charge electrode 148 from the nozzle body 143 (which is grounded). The charge electrode 148 abuts the boot 151 such that the boot 151 is sandwiched between the charge electrode 148 and the chamber housing 162. The boot 151 also facilitates adjustment of the charge electrode 148 with respect to the chamber housing 162 by allowing a degree of movement of the charge electrode 148 with respect to the chamber housing 162.

The charge electrode 148 is provided in communication with the chamber 164 by a channel 189. In use, as indicated in FIG. 7, a stream of ink droplets 188 is generated and ejected by the nozzle 144 and travel through the chamber 164 via the charge electrode 148 and the first channel 189. Having passed through the charge electrode 148 the stream of ink droplets 188 has a charge applied to them. The selectively charged stream of ink droplets 188 can be selectively deflected by the deflection electrode 168 for printing. A stream of ink droplets which has been deflected for printing by the deflection electrode 168 is labelled 190 in FIG. 7. A stream of ink droplets which are not used for printing, and which have therefore not been deflected by the deflection electrode 168, is labelled 194. The stream of ink droplets 194 not used for printing are received by a gutter aperture 183 of the gutter block 182. Part of a gutter conduit 196, defined by the gutter aperture 183, is also visible in FIG. 7. This is the conduit through which the droplets of ink 194 which are not used for printing, and which are received by the gutter aperture 183, travel.

For completeness, in FIG. 7 the rotatable body 122 of the sealing mechanism 124 is shown in the second, closed configuration. As such, none of the streams of ink droplets 188, 190, 194 would be present when the sealing mechanism 124 is in the configuration shown in FIG. 7. FIG. 7 indicates that the gutter block 182 is at least partially received by the casing 170 and, although not visible in FIG. 7, the chamber 164 also extends behind the gutter block 182 as shown in FIG. 7 (e.g. into the plane of the page). This is, however, visible in FIG. 8 and will be described in connection with the same.

Returning to FIG. 7, the sealing mechanism 124 comprising the rotatable body 122 rotatably coupled to the gear 134 is also shown. A shaft 198 of the rotatable body 122 is also visible. It is about the shaft 198 that the rotatable body 122 rotates about the axis of rotation 126 in use. The shaft 198 is received by a recess 199 of the cap 172 to constrain and locate the rotatable body 122.

An ink aperture 171 defined by the casing 170 is also visible in FIG. 7. The rotatable body 122 effectively closes the ink aperture 171 in the configuration shown in FIG. 7. In a first, open configuration, in which the rotatable body 122 is rotated relative to the positon shown in FIG. 7, the ink aperture 171 is effectively opened such that the stream of ink droplets 190 can pass across the rotatable body 122, through the ink aperture 171, via an ink path 190. As the stream of ink droplets 188 passes across the chamber 164, the phase detector forming part of the low voltage electrode 166 also operates to detect the phase of the ink particles. Of note, as shown in FIG. 2 the end cap 104 defines the ink aperture 106. The ink aperture 171 shown in FIG. 7 overlaps the ink aperture 106 defined by the end cap 104, and the ink aperture 106 can therefore also be considered to be opened/closed by the rotatable body 104 (at least by virtue of being downstream of the ink aperture 171).

Finally, also shown in FIG. 7 is the recess 200 defined in the gutter block 182. As described in connection with FIG. 6, the recess 200 partly defines the port 202 which is used for cleaning and draining.

Turning to FIG. 8, an alternative cross-section view to that shown in FIG. 7 is provided. In FIG. 8 the subassembly of FIGS. 6 and 7 is shown by way of a cross-section view as indicated by the annotations 186 in FIG. 6. FIG. 8 may therefore be described as a cross-section plan view of the subassembly.

As described in connection with FIG. 7, FIG. 8 also shows the nozzle body 143, insulating coupling 150, charge electrode 148 and boot 151. FIG. 8 also shows the low voltage electrode 166 being located within the chamber 164. Also visible in FIG. 8 is a phase detector electrode 166b (which may be referred to as a phase pickup electrode) and a velocity detector electrode 166c. The electrodes 166b, 166c (and low voltage electrode 166) are etched into the PCB (e.g. a rear of the PCB, in the illustrated embodiment) which defines the low voltage electrode 166. The combination of the electrodes 166, 166b, 166c may be referred to as a phase detector assembly. The phase detector electrode 166b is configured to determine a magnitude of charge applied to the droplets of ink as they move past the phase detector electrode 166b. Measurements from the phase detector electrode 166b are used to determine when to apply a voltage to the charge electrode 148. The velocity detector electrode 166c is configured to determine the velocity of the droplets of ink as they move past the electrode 166b. The velocity is determined by measuring the time between the charge ‘pulse’ being detected by the phase detector electrode 166b and subsequently by the velocity detector electrode 166c, and dividing the distance between the electrodes 166b, 166c by that time. The low voltage electrode 166 takes the form of an Electroless Nickel Immersion Gold (ENIG) coated copper ground plate in the illustrated embodiment. The low voltage electrode 166 acts as the OV plate for the deflection electrode, which establishes the EHT field that deflects the stream of ink droplets in use. The phase detector electrode 166b and velocity detector electrode 166c are covered by an insulator (e.g. a solder resist in the illustrated embodiment). This prevents ink and/or solvent shorting the electrodes 166b, 166c to the low voltage electrode 166.

Owing to each of the: phase detector electrode 166b, velocity detector electrode 166c, low voltage electrode 166 and deflection electrode 168 (not shown in FIG. 8) being disposed in the chamber 164, all of these components can be cleaned during a cleaning cycle. Similarly, the charge electrode 148, although located outside of the chamber 164, can also be cleaned in a cleaning cycle by virtue of a third port or charge electrode drain port (not visible in FIG. 8).

FIG. 8 does show that in the illustrated embodiment the chamber 164 comprises first and second chamber portions 164g, 164h. The first chamber portion 164g is defined by the chamber housing 162. The second chamber portion 164h is defined by the casing 170. As such, the chamber 164 may be said to be at least partially defined by the casing 170 in the illustrated embodiment. In other embodiments it will be appreciated that the chamber housing 162 could be integral with the casing 170 such that the chamber 164 be defined entirely by the casing 170.

FIG. 8 also shows the chamber housing 162 comprises a (first) conduit 204 which extends partly through the chamber housing 162 and is in communication with the chamber 164 via a port 206. The port 206 may therefore be said to at least partly define the chamber 164. The conduit 204 is multipurpose in that it can be used to either supply the chamber 164 with cleaning fluid or to drain used cleaning fluid from the chamber 164. The conduit 204 may therefore be described as a chamber cleaning and draining channel. The conduit 204 may specifically be described as an upstream chamber cleaning/draining channel, owing to it being disposed proximate the channel 190 through which ink droplets are ejected into the chamber 164.

FIG. 8 also shows more features of the gutter block 182. As mentioned in connection with FIG. 7, the gutter block 182 comprises the gutter aperture 183 through which ink droplets which are not to be used for printing are received/collected. The gutter aperture 183 defines an upstream end of the gutter conduit 196 which extends through the gutter block 182. At a point downstream, the gutter conduit 196 appears to branch off to a recess 210. The recess 210 is sealed in use, and is only to facilitate manufacture of the gutter conduit 196 through the gutter block 182. Further downstream of the gutter conduit 196 is a return conduit 212 defined at least partly by the chamber housing 162. The return conduit 212 is provided in fluid communication with the gutter conduit 196, and so the gutter aperture 183. Ink droplets which are not used for printing are thus received by the gutter aperture 183 and are drawn through the gutter conduit 196 and the return conduit 212 by suction. The unused ink droplets are then returned to the mixer tank. For completeness, the gutter block 182 is sealed against the chamber housing 162 by seal 213.

In the illustrated embodiment the gutter block 182 forms a separate component which is fixedly coupled to the chamber housing 162. In other embodiments (e.g. FIGS. 17, 18), at least part of the gutter may rotatably coupled to the rotatable body 122, and may be integral with the rotatable body 122. Partially shown in FIG. 8 is a recess 123 of the rotatable body 122.

When the rotatable body 122 is in the second configuration as shown in FIG. 8, in which the rotatable body 122 closes the ink aperture 171, the gutter block 182 is partially received by a recess 123 of the rotatable body 122. When the rotatable body 122 is in a first configuration, in which an ink path is defined across the rotatable body 122 and through the ink aperture 171, the rotatable body 122 is effectively rotated counter clockwise by around 90° such that the gutter block 182 is still partially received by the recess 123 but in a different orientation. This will be described in greater detail in connection with FIGS. 10 and 11.

Referring now to FIG. 9, a schematic diagram of a fluid system for the printer of FIG. 1, incorporating the print head 3, is shown. The ink jet printer 1 comprises the ink system 5 which is contained within the main printer body 2. The ink system 5 comprises at least the components that form part of a main ink block 11. The ink system may further comprise a cartridge module 12 and a cleaning module 13. Components of the print head are schematically indicated 3.

Beginning with the main ink block 11, the main ink block 11 comprises a mixer tank 17 (which may also be referred to as an ink feed, or ink supply, tank) configured to supply ink along a main supply line 19. The ink is drawn from the mixer tank 17 by an ink pump 21. Ink also passes through a first filter 23, downstream of the ink pump 21, disposed along the main supply line 19. The first filter 23 removes any particles (e.g. sediment) contained within the mixer tank 17. The first filter 23 is a 100 micron filter in the illustrated embodiment, but it will be appreciated other sizes of filter could otherwise be used. A Venturi line 24 is connected to the main supply line 19 downstream of the first filter 23. Provided along the Venturi line 24 is a Venturi 24a (e.g. a restriction). In operation, fluid (e.g. an ink mixture) is continuously circulated from the mixer tank 17, through the main supply line 19, through the Venturi line 24, and so through the Venturi 24a, before being returned to the mixer tank 17. This continuous circulation, combined with the Venturi 24a, creates suction to draw fluids into the mixer tank 17 via a refill line 25, which extends between the cartridge module 12 and the Venturi 24a. Fluids are drawn into the mixer tank 17 through the Venturi 24a and a downstream portion 24b of the Venturi line 24.

The ink pump 21 may be operated as a pressure controlled pump, meaning that the ink flow rate through the pump 21 will be adapted as necessary to maintain a target pressure downstream of the ink pump 21 (e.g. as monitored by a pressure sensor 33). The ink pump 21 may be configured to supply ink to the print head 3 at a predetermined system operating pressure, which may be determined based upon the printer configuration (e.g. nozzle geometry). For example, a nozzle having a diameter of 75 μm may require a lower operating pressure than a nozzle having a diameter of 62 μm to achieve a similar jetting performance (e.g. ink droplet breakup location, or flight time to breakup). The system operating pressure may also be varied in dependence upon other system parameters (e.g. ink type, viscosity).

A second filter 26, having a filtration size of 5 microns, is provided downstream of the first filter 23 along the main supply line 19. A damper 27 is provided downstream of the ink pump 21, and downstream of the second filter 26, to reduce fluctuations in ink pressure within the ink supply. Downstream of the damper 27, a load line 28 branches off the main supply line 19. The load line 28 comprises a restriction 29. The load line 28 is configured to maintain a near-constant load on the main supply line 19, avoiding pressure spikes in the print head 3 due to load spikes of the ink pump 21 (e.g. due to activation of the ink pump 21). A viscometer valve 30 is disposed along the load line 28. The viscometer valve 30 can selectively place the load line 28 in fluid communication with either the mixer tank 17, via a tank line 31, or a viscometer 32. The viscometer valve's 30 default configuration is to place the load line 28 in fluid communication with the mixer tank 17. This creates a circular fluid flow path. When it is desired to ascertain the viscosity of the ink mixture in the main supply line 19, and so the load line 28, the viscometer valve 30 is energised to direct the flow into the viscometer 32. Initially the viscometer 32 is empty. By monitoring the time taken to fill and/or empty the viscometer 32, and based upon a known volume of fluid in the viscometer 32, the viscosity of the ink mixture can be ascertained.

Downstream of the damper 27 and the load line 28, a pressure sensor 33 is connected to the main supply line 19 and is configured to monitor the pressure downstream of the ink pump 21. The ink pump 21 may be operated as a constant pressure pump (i.e. the pump is controlled to maintain a constant output pressure). A third filter 34, having a filtration size of 15 microns, is provided downstream of the pressure sensor 33.

The main supply line 19 is configured to carry ink from the ink mixer tank 17, along the umbilical 4, to the print head 3. The main supply line 19 is connected to the print head 3 via a feed valve 35. The feed valve 35 is configured to control the ink supply to the print head 3. Downstream of the feed valve 35 a heater 36 is provided. The heater 36 is used to control the temperature of the ink mixture. Controlling the temperature of the ink mixture reduces the effect that temperature fluctuations could otherwise have on the viscosity of the ink mixture. For example, activation of the heater 36 provides a heating effect which reduces the viscosity of the ink mixture. A temperature sensor 37 is provided downstream of the heater 36. The heater 36 is provided in fluid communication with the nozzle body 143, and so nozzle 144, via a nozzle line 38. The heater 36 preferably maintains the ink mixture at a temperature of at least around 308° K (e.g. ˜35° C.).

As described above, ink is fed along the main supply line 19 to the print head 3 via the umbilical 4. Within the print head 3 the ink is provided to the nozzle 144. The ink is provided to the nozzle 144 under pressure (under the influence of the ink pump 21) and forms an ink jet. The ink jet begins as a constant stream of ink and, under the influence of surface tension and vibrations applied in the nozzle body 143 (e.g. by a piezoelectric oscillator), gradually separates into a series of ink droplets 188 which continue to travel in the direction of the ink jet 57.

Shortly after emerging from the nozzle 144 of the nozzle body 143, the ink jet is passed through a charge electrode (not shown in FIG. 9, but labelled 148 in FIG. 3). The point at which the continuous ink jet separates into droplets 188 is arranged to occur within the charge electrode. The ink is an electrically conductive liquid, and the nozzle body 143 is conventionally held at a fixed (e.g. ground) potential. A variable voltage is applied to the charge electrode (not shown in FIG. 9 but labelled 148 in FIG. 3) causing charge to be induced on the continuous stream of ink droplets extending from the nozzle body 143 towards the charge electrode. As the continuous stream of ink (i.e. ink jet) separates into droplets 188, any charge induced on the ink within the droplet becomes trapped at the moment the individual droplet “snaps” off from the main stream of ink. In this way, a variable charge can be applied to each of the ink droplets within in the stream of ink droplets 188.

The stream of ink droplets 188 then continues to pass from the charge electrode between further electrodes (not shown in FIG. 9, but labelled 166, 168 in FIG. 3). A first electrode (e.g. a low voltage electrode) is held at a first voltage, whereas the second electrode (e.g. deflection electrode) is held at second voltage, with a large potential difference (e.g. 8-10 kilovolts) established between the electrodes. In some systems, one electrode may be maintained at a ground potential while the other electrode is held at a high (positive or negative) voltage (with respect to ground). In other systems, one electrode is held at a negative voltage (with respect to ground) and the other electrode is held at a positive voltage (with respect to ground). The electric field established between the electrodes causes any charged droplets (i.e. those that have been charged by the charge electrode) to be deflected. In this way, based upon the variable charge applied by charge electrode, the droplets 188 can be selectively (and variably) steered from the path along which they are emitted from the nozzle 144.

Droplets which pass through the deflection field and which are deflected by the electrodes are not shown in FIG. 9, but are labelled 190 in FIG. 7. The stream of droplets 190 are used for printing. The stream of ink droplets 190 may be described as defining an ink path across the rotatable body (of the sealing mechanism) and through the ink aperture.

Returning to FIG. 9, droplets which pass through the deflection field without being deflected (i.e. droplets which are not used for printing) travel to a gutter 40 (e.g. the gutter block 182 of the earlier Figures). The gutter 40 comprises an orifice 183 (e.g. gutter aperture 183 of the earlier Figures) into which the droplets enter. The gutter 40 is connected to a gutter line 42 which extends from the gutter 40 back to the main ink block 11 (e.g. the gutter line 42 extends between at least the gutter 40 and the gutter pump 46). A gutter valve 44 is optionally provided within the gutter line 42 enabling the gutter line 42 to be opened and closed. A suction force is applied to the gutter line 42 by a gutter pump 46 to draw ink along the line from the gutter 40 back towards the main ink block 11. In other embodiments the suction may be provided by a Venturi in communication with the ink pump 21.

Downstream of the gutter pump 46 a tank valve 48 is provided. The tank valve 48 selectively places the gutter pump 46 in fluid communication with either the mixer tank 17 or a solvent tank 50 (which may be described as a ‘used’ solvent reservoir). In the illustrated embodiment, the solvent tank 50 is provided adjacent the mixer tank 17. The solvent tank 40 and mixer tank 17 are shown as different compartments within an overall tank in the illustrated embodiment, but in other embodiments the mixer and solvent tanks 17, 40 could be physically separate tanks. During printing operations, the tank valve 48 places the gutter pump 46 in fluid communication with the mixer tank 17. The ink mixture (e.g. the stream of ink droplets 188) received by the gutter 40 is thus returned to the mixer tank 17 and can be recirculated/reused at a later time. During non-printing operations (e.g. such as priming, cleaning operations etc.), the tank valve 48 may place the gutter pump 46 in fluid communication with the solvent tank 50. This is to avoid cleaning fluid, such as ‘used’ solvent, undesirably contaminating (e.g. altering the viscosity of) the ink mixture in the mixer tank 17.

In addition to unprinted droplets of ink being recirculated via the gutter 40, any air which is sucked into the gutter 40 will also be delivered to the mixer tank 17 or solvent tank 50. The mixer tank 17 and solvent tank 50 are in communication with one another via a condenser 52 (which also acts as a vent). Solvent in the ink mixture in the mixer tank 17 tends to evaporate as solvent vapour in the mixer tank 17. Saturated solvent vapour is therefore present in the mixer tank 17 during use. As said vapour passes over the condenser 52, the comparatively cool surfaces of the condenser 52 result in the solvent, contained in the vapour, condensing. The solvent vapour thus returns to liquid, and is deposited back into the solvent tank 50. This advantageously avoids undue loss of solvent from within the system (which would otherwise occur if both tanks were vented directly to atmosphere). Furthermore, the mixer tank 17 is effectively vented by the condenser 52, preventing excess pressure building up within the mixer tank 17. Gases vented from the mixer tank 17 thus travel into the solvent tank 50. In turn, the solvent tank 50 is vented by a solvent tank vent line 54 provided in fluid communication with the solvent tank 50. Through solvent tank vent line 54 gases can be vented, preferably to outside of the printer cabinet (in which the ink system is contained).

The ink system, specifically the cartridge module 12 thereof, comprises an ink cartridge connection 56 which may be connected to the associated ink cartridge 8 and a solvent cartridge connection 58 which may be connected to the associated solvent cartridge 10. The ink cartridge 56 and ink cartridge connection 58 are connected to the refill line 25, allowing ink or solvent to be drawn, by the Venturi line 24, into the mixer tank 17. In other embodiments, a dedicated transfer pump may be used instead of the Venturi line 24.

By using a Venturi in this way (i.e. as a jet pump), a system can be designed in which the main system ink pump 21 can generate both positive pressures (e.g. to supply ink to the print head 3) and negative vacuum pressure (e.g. to draw ink or solvent into the mixer tank 17 via the refill line 25).

The feed valve 27, provided along main supply line 19, is configured to prevent the main supply line 19 from being continuously open. However, since the feed valve 27 is provided downstream of the Venturi line 24, even when the feed valve 27 is closed, when the ink pump 21 is operating, a flow of ink will flow along Venturi line 24 through the Venturi 24a, resulting in suction being applied to the refill line 25. In this way, the suction can be applied even when ink is not being supplied to the print head 3. Of course, a second valve 61 may also be operated to block the refill line 25, meaning that the refill line suction can be controlled independently of the Venturi 24a.

It will be appreciated that by selectively activating one or more of four cartridge valves 60, 61, 62, 63, the ink cartridge 56 can be placed in fluid communication with the refill line 25. For example, opening only first and second valves 60, 61 (and closing third and fourth valves 62, 63) places the ink cartridge 8 in fluid communication with the refill line 25 via an ink refill line 59. Ink can thus be drawn into the mixer tank 17, via the ink refill line 59 and refill line 25, to add ink to the mixer tank 17.

Solvent can be directed to the solvent tank 50, directly from the solvent cartridge 58, by the solvent refill line 64 and a solvent tank line 65. Closing the first and second valves 60, 61, and opening third and fourth valves 62, 63, places the solvent cartridge 10 in fluid communication with the solvent tank 50 via the solvent tank line 65 and the solvent refill line 64. Solvent can also be drawn from the solvent tank 50, through the solvent tank line 65 and into the cleaning module inlet line 72 (which will be described below). A solvent tank refill line filter 66 is provided along the solvent tank refill line 64. A solvent pump 67 is provided downstream of the solvent cartridge 10 along the solvent refill line 64. Activation of the solvent pump 67 can be used to pump solvent from the solvent cartridge 10 into the solvent tank 50. Advantageously, the amount of solvent added to the solvent tank 50 can be measured by determining the fluid level within the solvent tank 50. This volume can then be subtracted from a remaining solvent cartridge volume held on a smart chip on the solvent cartridge 10. The remaining volume of solvent in the solvent cartridge 10 can thus be ascertained. This has been found to be more accurate than measuring the volume of solvent drawn out of the solvent cartridge 10 under a negative pressure (owing to the vacuum level within a cartridge generally changing as the cartridge is evacuated of fluid). In the illustrated embodiment, solvent is pumped out of the solvent cartridge 10 under action of the solvent pump 67.

When it is desired to add solvent to the mixer tank 17, second and fourth valves 61, 63 are opened, and first and third valves 60, 62 closed. Solvent is then drawn from the solvent reservoir 50, via solvent tank line 65 and refill line 25, by Venturi 24a, into the mixer tank 17.

Activation of the solvent pump 67 can also be used to pump solvent from the solvent cartridge 10, along the solvent refill line 64, for some non-printing operations, such as priming the fluid circuit. The solvent pump 67 is not used to actively pump pressurised cleaning fluid (e.g. solvent) into the chamber 164, via the cleaning module inlet line 72, for cleaning in the illustrated embodiment. Instead, cleaning fluid is preferably drawn into the chamber 164 under vacuum for cleaning. This provides failsafe operation, should the sealing mechanism fail, in that the cleaning fluid will just not be drawn into the chamber 164. Were the cleaning fluid pumped into the chamber 164 under pressure (e.g. under action of an upstream pump), failure of the sealing mechanism risks cleaning fluid being ejected from the print head 3 (e.g. via the ink aperture) onto the printing line. This risks undesirable contamination. That said, cleaning fluid could equally be pumped into the chamber in some embodiments.

A non-return valve 68 is provided downstream of the solvent pump 66, along the solvent refill line 64, to prevent fluid travelling past the non-return valve 68 towards the solvent pump 66. A further non-return valve 69 is provided in a branch line which extends around the solvent pump 67. The non-return valve 69 is an overpressure valve for the solvent pump 67. The non-return valve 69 is a pressure relief valve which determines a maximum solvent pressure from the solvent pump 67. For completeness, the cartridge valves 60-63 can also be selectively activated to provide other configurations for, for example, priming of the fluid system and for draining the mixer tank 17 and/or solvent tank 50 (e.g. during maintenance).

A flush line 70 is connected between the third valve 62 and the non-return valve 68. The flush line 70 directly connects the cartridge module 12 to the print head 3 via the umbilical 4. A flush filter 71 is provided along the flush line 70, upstream of a cleaning module inlet line 72 which branches off the flush line 70. The flush line 70 extends to the print head 3 via a flush valve 73 disposed along the flush line 70. The flush line 70 is used to route solvent from the solvent cartridge 58 into the nozzle body 143. Solvent can thus be forced through the nozzle 144 to clean the nozzle. This is by way of activating the solvent pump 67, which provides pressurised solvent to the nozzle 144 for nozzle cleaning. The flush valve 73 is closed by default (e.g. during printing operations) and is only opened during non-printing operations (e.g. priming). Solvent can be prevented from being pumped into the chamber 164 via the cleaning module inlet line 72 by selective activation of valves in the cleaning module 13. Put another way, the cleaning module inlet line 72 can effectively be closed, so that solvent flows through the flush line 70 to the flush valve 73, by selective activation of valves in the cleaning module 13.

A purge line 74 is connected to the nozzle body 143. The purge line 74 is connected to a purge port 74a of the nozzle body 143. The nozzle body 143 may be provided as part of a nozzle assembly, which includes the nozzle body 143 having known acoustic properties, and a piezoelectric oscillator. The purge port may be provided by the body, or by a separate part connected to the body. The purge line 74 allows ink (and/or air and/or debris) to flow (or pass) out of the nozzle body 143 via a purge aperture 74a (e.g. a purge port) without passing through the nozzle 144, and allows the nozzle body 143 to be cleaned. The purge line 74 extends from the nozzle body 143, along the umbilical 4, and returns ink (or solvent), depending upon the phase of operation, to the mixer tank 17. The purge line 74 is provided in selective fluid communication with the gutter pump 46, via purge valve 75. Fluid is drawn through the purge line 74 by suction of the downstream gutter pump 46. A purge valve 75 is provided along the purge line 74. It will be understood that the purge line is not essential, and may be omitted in some printers. The incorporation of the purge line 74 is advantageous for a number of reasons. The purge line 74 can be used to remove air from the nozzle body 143 (e.g. from within a chamber of the nozzle body 143). Removal of air from the nozzle body 143 is desirable because the presence of air can negatively impact the acoustic performance of the nozzle body 143. The purge line 74 can also be used to remove debris that may become trapped in the nozzle chamber when a backflush is carried out. A backflush refers to a process in which solvent is applied to a front face of the nozzle 144 whilst a vacuum is generated in the nozzle body. The purge line 74 also allows ink to be removed/drained from the interior of the nozzle body 144, and the interior of the nozzle body 144 washed, more effectively.

The main supply line 19, purge line 74, gutter line 42, and flush line 70 thus connect the ink system (e.g. the main ink block 11 and cartridge block 12) to the print head 3. Additional fluid connections housed within the umbilical 4 may connect the ink system 5 to the print head 3. For example, an air recirculation line may be provided to provide solvent saturated air to the gutter line 42 close to the gutter entrance.

The chamber 164 is also schematically indicated in FIG. 9. As indicated in FIG. 9, the gutter 40 is disposed in the chamber 164 in the illustrated embodiment. The nozzle body 143 is outside of the chamber 164 in the illustrated embodiment. Two conduits 204, 214 are shown connected to the chamber 164. The first conduit 204 is also shown in FIG. 8. The first conduit 204 is in fluid communication with the chamber 164 via the first port 206. The first port 206 is disposed proximate the charge electrode and nozzle body 144 (e.g. at an upstream location within the chamber 164). The second conduit 214 is in fluid communication with the chamber 164 via the second port 202. The second port 202 is disposed proximate the gutter 40 (e.g. the gutter block 183 in FIG. 6). The second port 202 is disposed at a downstream location within the chamber 164. The first and second conduits 204, 214, and so first and second ports 206, 202, can be used to supply the chamber 164 with cleaning fluid or to drain used cleaning fluid from the chamber 164. The first and second conduits 204, 214, and so first and second ports 206, 202, can be used to supply the chamber 164 with air (e.g. for drying the chamber or for pressure balancing during printing. Each of the first and second conduits 204, 214 can be selectively opened/closed by action of corresponding valves of the cleaning module 13.

Also shown in FIG. 9 is a third conduit 216 which extends from the first conduit 204 to, and partway through, the nozzle body 143. The third conduit 216 may therefore be described as a branch of the first conduit 204. The third conduit 216 terminates at a third port 217. The third port 217 is defined in a front face of the nozzle body 143. The third conduit 216 and third port 217 are optional features of the illustrated embodiment, and may be omitted in other embodiments. The third conduit 216, and corresponding third port 217, is used to supply at least part of the charge electrode, and so downstream chamber, with cleaning fluid or to drain used cleaning fluid from the at least part of the charge electrode and chamber 164 (or provide a supply of air). By virtue of being a branch of the first conduit 204, the third conduit 216 is not independently controllable of the first conduit 204 in the illustrated embodiment. Described another way, in the illustrated embodiment, when cleaning fluid is supplied through the first conduit 204, cleaning fluid is ejected from both the first port 206 (into the chamber 164) and the third port 217 (into at least part of the charge electrode). Similarly, where used cleaning fluid is drained through the first conduit 204, cleaning fluid is drained from the chamber 164 (through the first port 206) and from at least part of the charge electrode (via the third port 217). In some orientations (e.g. vertically upwards) of the print head 3, and so chamber 164, used cleaning fluid can be drained through both the first and third ports 206, 217. Advantageously, the first port 206 drains fluid from the chamber 164, whilst the third port 217 drains fluid from the charge electrode. Incorporation of the third port 217 thus avoids an accumulation of used cleaning fluid outside of the chamber 164 which could otherwise undesirably increase the drying time of the print head 3 following cleaning. However, in other embodiments one or more valves may be incorporated along the first and/or third conduits 204, 216 to provide independent control.

The third port 217 may also be referred to as the charge electrode drain port.

Turning to describe components of the cleaning module 13, first to fourth control valves 80, 81, 82, 83 are provided. Also extending at least partway through the cleaning module 13 is an air line 84, with an air pump 85 provided along the air line 84. A pressure release valve 86 is also provided downstream of the air pump 85. The air line 84 is connected to atmosphere and can be used to selectively supply the chamber 164 with air. This can be used for either positive pressure drying of the chamber 164 (e.g. after cleaning) or to provide a supply of air to within the chamber 164 during printing. This is to avoid an excessive negative pressure being generated within the chamber 164 due to the suction of the gutter pump 46 via the gutter 40, which could otherwise result in debris being drawn into the print head 3 from the printing line. Advantageously the single air pump 85 provides both functionalities.

A downstream portion of the cleaning module inlet line 72, which may be referred to as an inlet line 72 for brevity, is also shown. The break in the inlet line 72 between the left hand side of the Figure (i.e. above the filter 71) and the right hand side of the Figure (i.e. above the air pump 85) is simply included to improve the clarity of the Figure, and to avoid the line extending across the various other components of the fluid circuit. A draw line 87 is also shown. The draw line 87 extends to the gutter pump 46 via part of the gutter line 42. Fluid can therefore be drawn through the draw line 87 by operation of the gutter pump 46. For completeness, the gutter valve 87 also forms part of the cleaning module 13 in the illustrated embodiment. However, in other embodiments the gutter valve 87 could form part of the main ink block 11.

The first control valve 80 can selectively place the first conduit 204 (via a second control valve 81) in fluid communication with the inlet line 72 or the air line 84. The other of the inlet line 72 and the air line 84 can be selectively closed by the first control valve 80.

The second control valve 81 can selectively place the first conduit 204 in fluid communication with the draw line 87 or the inlet line 72 (via the first control valve 80) or the air line 84 (via the first control valve 80). In the configuration shown in FIG. 9, the second control valve 81 places the first conduit 204 in fluid communication with the draw line 87. Activation of the gutter pump 46 thus applies suction through the draw line 87 and through the first conduit 204. In this configuration, fluid would be drawn from the chamber 164 through the first conduit 204 and draw line 84. In the configuration shown in FIG. 9, the first conduit 204 is not provided in fluid communication with either of the inlet line 72 and the air line 84.

The third control valve 82 can selectively place the second conduit 214 in fluid communication with the draw line 87 or the inlet line 72 (via the fourth control valve 83) or the air line 84 (via the fourth control valve 83). In the configuration shown in FIG. 9, the third control valve 82 places the second conduit 214 in fluid communication with the draw line 87. Activation of the gutter pump 46 thus applies suction through the draw line 87 and through the second conduit 214. In this configuration, fluid would be drawn from the chamber 164 through the second conduit 214 and draw line 87. In the configuration shown in FIG. 9, the second conduit 214 is not provided in fluid communication with either of the inlet line 72 and the air line 84.

The fourth control valve 83 can selectively place the second conduit 214 (via the third control valve 82) in fluid communication with the inlet line 72 or the air line 84. The other of the inlet line 72 and the air line 84 can be selectively closed by the fourth control valve 83.

By selective operation of the control valves 80-83, different conduits/ports can be placed in fluid communication with the inlet line 72, air line 84 and draw line 87. When connected to the inlet line 72, cleaning fluid can be directed through the conduits/ports into the chamber 164. When connected to the air line 84, air can be pumped through the conduits/ports, by the air pump 85, into the chamber 164. When connected to the draw line 87, fluid (e.g. used cleaning fluid) can be drawn from the chamber 164, through the conduits/ports, through the draw line 87 by gutter pump 46. The air line 84 can be used to pump air into the chamber 164 to dry the chamber 164 after cleaning fluid has been drawn into, and drawn out of, the chamber 164. The air line 84 can also be used to pump air into the print head 3 (e.g. into the chamber 164) to replenish the air removed from the chamber 164 under action of the gutter 40 (e.g. during printing operations). This advantageously reduces the risk that the pressure within the print head 3 reduces to such a level that debris is drawn into the print head 3 from outside the print head 3.

In preferred embodiments, one of the first and second conduits 204, 214 is placed in fluid communication with the inlet line 72, and the other of the first and second conduits 204, 214 is placed in fluid communication with the draw line 87. Activation of the gutter pump 46 then draws cleaning fluid through the inlet line 72, into the chamber 164 via the conduit connected to the inlet line 72. The cleaning fluid is then drawn back out of the chamber 164, via the other conduit (e.g. whichever of the first or second conduits 204, 214 is not connected to the inlet line 72), under suction of the gutter pump 46 via the draw line 87. The cleaning fluid is preferably drawn back out of the chamber 164, via the same conduit (e.g. whichever of the first or second conduits 204, 214 was connected to the inlet line 72), under suction of the gutter pump 46 via the draw line 87. The selection of which port is a fill port, and which port is a drain port, can be based upon the orientation of the print head 3, and so chamber 164.

In preferred embodiments cleaning fluid is left in/resides in the chamber 164 for a dwell time before subsequently being drawn out/drained. Air may be bubbled through the chamber 164, whilst it is at least partly filled with cleaning fluid, to agitate the cleaning fluid and dislodge debris within the chamber 164. The chamber 164 may be only partially filled with cleaning fluid (e.g. around half full). The chamber 164 may be majority filled with cleaning fluid (e.g. at least around 80% of the chamber 164 volume filled with cleaning fluid). The chamber 164 may be partly filled with cleaning fluid in combination with, or in isolation of, air being bubbled through the chamber 164.

There is now described a method of performing a self-cleaning operation on a self-cleaning-marking head. In the following example, the marking head is a self-cleaning print head, such as that described above with respect to FIGS. 1 to 9, e.g. print head 3, and the industrial printer is a continuous inkjet printer such as the one described above with respect to FIGS. 1 to 9, e.g. continuous inkjet printer 1. However, in other examples, the self-cleaning marking head may be a self-cleaning laser, and the industrial printer a laser printer.

With reference to FIG. 10, there is shown a production line 1001 on which a continuous inkjet printer 1002 is operating. The continuous inkjet printer 1002 is configured to mark products 1008 travelling along conveyor 1013 (in direction A) with self-cleaning print head 1006. The continuous inkjet printer 1002 comprises the self-cleaning print head 1006, processor 1003 (also referred to as an internal controller), memory 1004 and transceiver 1005. The processor 1003 controls the continuous inkjet printer 1002, and provides logic for the continuous inkjet printer 1002. That is, where it is described herein that the continuous inkjet printer 1002 makes a decision, or carries out an operation, it is processor 1003 of the continuous inkjet printer 1002 that is providing that logic or control. The transceiver 1005 of the printer 1002 is connected to a transceiver 1012 of an external controller 1009 via network 1007. This connection allows data to pass between the printer 1002 and the external controller 1009. Network 1007 may be any suitable network, wired or wireless, that facilitates the transmission of data (e.g. computer data suitable for processing by a processor). The external controller 1009 comprises a processor 1010, memory 1011 and the transceiver 1012. The external controller 1009 may have control of the production line 1001, or at least visibility as to the status of components of the production line. The external control 1009 may have said visibility via one or more sensors that monitor the production line 1001. The external controller 1009 may be a filling machine, weighing machine, cutting machine, or any other production equipment that operates on the production line. The external controller 1009 is located at the same site as the production line 1001 in FIG. 1, but it will be appreciated that the external controller 1009 could be located in the cloud. That is, the external controller may be a server operating in the cloud, and the continuous inkjet printer 1002 may connect to the external controller 1009 using, for example, the internet.

During normal operation of the continuous inkjet printer 1002, products 1008 travel along conveyor 1013 and past the continuous inkjet printer 1002. When a given product 1008 passes adjacent to the self-cleaning print head 1006 of the continuous inkjet printer 1002, the continuous inkjet printer 1002 marks the product 1008 using the self-cleaning print head 1006. The mark may be, for example, a best before date, lot number, batch number, barcode, etc.

A flow chart depicting a method for cleaning the self-cleaning print head 1006 of the continuous inkjet printer 1002 is shown in FIG. 11. At Step S1, the continuous inkjet printer 1002 receives a control signal from the external controller 1009. As noted above, continuous inkjet printers require cleaning. In order to facilitate cleaning, the external controller 1009 is configured to send the control signal to the continuous inkjet printer 1002, the control signal configured to cause the continuous inkjet printer 1002 to carry out a self-cleaning operation of the self-cleaning print head 1006. That is, when the continuous inkjet printer 1002 receives the control signal from the external controller 1009, the continuous inkjet printer 1002 carries out a self-cleaning operation in response. In this way, greater control over when the continuous inkjet printer 1002 carries out maintenance is achieved as the external controller 1009, having an overview of the status of the production line 1001, can automatically decide the most appropriate time to carry out the self-cleaning operation. For example, the most appropriate time may be a time that provides minimal disruption to the ordinary running of the production line 1001.

The external controller 1009 may send the control signal to the continuous inkjet printer 1002 based on a predetermined condition being satisfied. For example, the predetermined condition may be a status of the production line 1001 on which the continuous inkjet printer 1002 is operating, such as a halt on the production line 1001. That is, the external controller 1009 may determine that the production line 1001 has been halted due to the failure of a component on the production line 1001, and in response generates and sends the control signal to the continuous inkjet printer 1002. For example, if the production line 1001 is halted due to failure of a component on the production line 1001, the self-cleaning operation may take place while the production line 1001 is halted, taking advantage of the unexpected downtime. The predetermined condition may additionally or alternatively comprise a predetermined time. For example, if it is known that the production line 1001 is going to be halted at a particular time in the future, such as due to a scheduled maintenance time or a scheduled change over of products on the line, the external controller 1009 may wait until the predetermined time arrives before sending the control signal to the continuous inkjet printer 1002. The predetermined time may be programmed into the external controller 1009 or may, for example, appear in a database (such as a digital calendar) to which the external controller 1009 has access.

The external controller 1009 may send the control signal to the continuous inkjet printer 1002 based on first receiving a signal from the continuous inkjet printer 1002. That is, if the continuous inkjet printer 1002 determines that a cleaning operation is required, the continuous inkjet printer 1002 may send a signal to the external controller 1009 indicating that self cleaning is required. The continuous inkjet printer 1002 may then wait to receive the control signal from the external controller 1009 before carrying out the self-cleaning operation. The external controller 1009, upon receipt of the signal from the continuous inkjet printer 1002, may wait until an appropriate time before sending the control signal to the continuous inkjet printer 1002. In this way, the external controller 1009 is alerted to the fact that cleaning is required, but is able to select an appropriate time (such as production line downtime) in which to allow the continuous inkjet printer 1002 to carry out self cleaning. The continuous inkjet printer 1002 may determine that a cleaning operation is required based on a condition having been met. The condition may be a scheduled time. For example, the scheduled time may be a predetermined time known to the continuous inkjet printer 1002 by which the continuous inkjet printer 1002 should carry out a self cleaning operation of the self-cleaning print head 1006. The condition may be a determination that no products have passed by the continuous inkjet printer 1002 for a predetermined period of time. For example, the continuous inkjet printer 1002 may have sensors (or access to data from external sensors), that detect the passing of products as they travel along a conveyor. If no products have passed by the continuous inkjet printer 1002 in the predetermined period of time, it may be assumed that the production line is idle and a self-cleaning operation of the self-cleaning print head 1006 can be performed without holding up the production line. Sensor data may be combined with temporal data. For example, the condition may be both a determination that no products have passed by the continuous inkjet printer 1002 for a predetermined period of time and a determination that the present time corresponds to the scheduled time described above.

The condition may comprise historical data. For example, the historical data may comprise an elapsed time and/or number of prints since a last failure event. For example, if it is determined that there has been an elapsed time and/or number of prints since a last failure event, the continuous inkjet printer 1002 may determine that the condition has been met. The historical data may comprise data indicating the average time between failures. For example, if it is determined that the continuous inkjet printer 1002 is approaching, or has reached, the average time before failure, the continuous inkjet printer 1002 may determine that the condition has been met. The historical data may comprise data indicating marking medium (e.g. ink) usage. For example, if a predetermined amount of marking medium has been used, the continuous inkjet printer 1002 may determine that the condition has been met. The historical data may comprise data indicating the mark being applied to the product and/or a number of individual marking actions (e.g. number of printed drops in the case of a continuous ink jet printer). For example, if a predetermined number of marks have been applied, or a predetermined number of individual marking actions have occurred, the continuous inkjet printer 1002 may determine that the condition has been met. The historical data may comprise data indicating historical environmental data, such as the ambient humidity, temperature, and/or pressure in the environment in which the continuous inkjet printer 1002 is operating. The environmental data may be collected over a predetermined period in which the continuous inkjet printer 1002 has been operating in. If the environmental data meets a predetermined condition, such as one or more of the humidity, temperature and/or pressure being above (or below) a certain level for certain period of time, the continuous inkjet printer 1002 may determine that the condition has been met. The continuous inkjet printer 1002 may have oen or more sensors that detect the environmental conditions, or may obtain this from external sensors.

The control signal may take any suitable form. For example, the control signal may comprise an analogue or digital signal. The signal may have a signature that can be detected by the continuous inkjet printer 1002, the signature indicating that a self-cleaning operation is to be performed. On receipt of the control signal, the processor 1003 causes the continuous inkjet printer 1002 to carry out the self-cleaning operation. That is, the processor 1003 controls the various components of the self-cleaning print head 1006, described above with reference to FIGS. 2-9, in order to clean the print head 1006. Alternatively, the control signal may comprise computer readable instructions that are executable by the processor 1003 of the continuous inkjet printer, and which when executed, caused the continuous inkjet printer 1002 to carry out the self-cleaning operation. The continuous inkjet printer 1002 may continually monitoring for signals received from the external controller 1009, and may be configured to act as soon as those signals (such as the control signal) is received. In this way, as soon as the control signal is received from the external controller 1009, the continuous inkjet printer 1002 can take appropriate action. The control signal may be transmitted as an electrical signal, using for example RS232 or Ethernet, etc. Alternatively, the control signal may be transmitted wirelessly (using a short range communication protocol for example), optically, magnetically, mechanically, hydraulically/pneumatically, etc.

At Step S2, the self-cleaning operation of the self-cleaning print head 1006 is executed in response to receiving the control signal. The self-cleaning operation comprises an intrinsic cleaning operation. That is, the self-cleaning operation does not require the use of external cleaning apparatus. An external cleaning apparatus may be an apparatus separate from the self-cleaning printhead 1006 and/or the continuous inkjet printer 1002. In this way, the self-cleaning print head 1006 is cleaned in situ, and does not require moving from its normal printing position (e.g. the normal position the print head 1006 would be in when applying marks to products) to a cleaning position (e.g. a position at which an external cleaning apparatus is located, or a position that allows an external cleaning apparatus to access the print head 1006 for cleaning). For example, it is not required that the self-cleaning print head 1006 be moved away from the surface of a product 1008 on which the self-cleaning print head 1006 is applying a mark in order to allow space for an external cleaning apparatus to gain access to and clean the self-cleaning print head 1006. The self-cleaning print head 1006 can instead remain in its normal printing position while it performs its self-cleaning operation.

The self-cleaning operation may be as that described above, and with respect to FIGS. 1 to 9.

Once the self-cleaning print head 1006 has completed the self-cleaning operation, the continuous inkjet printer 1002 may inform the external controller 1009. For example, the continuous inkjet printer 1002 may generate data indicating that the self-cleaning operation is complete and then send the data indicating that the self-cleaning operation is complete to the external controller 1009. In this way, the continuous inkjet printer 1002 can inform the external controller 1009 that cleaning is complete, indicating that the continuous inkjet printer 1002 is ready to print again. The continuous inkjet printer 1002 may be configured to automatically begin marking products again following completion of cleaning. That is, when the cleaning is complete and the production line 1001 is restarted, the continuous inkjet printer 1002 may begin marking products again as they pass by the printer 1002 on the production line 1001. Alternatively, the continuous inkjet printer 1002 may be configured to wait for a further control signal from the external controller 1009 before marking products 1008, the further control signal configured to cause the continuous inkjet printer 1002 to begin marking products 1008 on the production line 1001.

An alternative method for cleaning a self-cleaning print head is depicted in the flow chart shown in FIG. 12. While described in the context of a continuous inkjet printer and self-cleaning print head, the method may of course be applied to an industrial printer and self-cleaning marking head.

At Step S3 sensor data indicative of an operation of the self-cleaning print head 1006 is obtained by the continuous inkjet printer 1002. The sensor data may be data output by one or more sensors of the continuous inkjet printer 1002, and which provide data indicating the status of the self-cleaning print head 1006. For example, there may be various sensors for various components of the continuous inkjet printer 1002. These sensors provide information on parameters related to the corresponding component. For example, the printhead 1006 may include a nozzle with sensor parameters such as the modulation voltage setpoint, modulation current, frequency, temperature, jet velocity setpoint, actual velocity, target pressure, temperature-compensated target pressure, and actual pressure; phase sensor parameters including selected phase, phase rate of change, profile, and phase threshold; EHT parameters such as voltage, current, trip value, and % of trip; gutter parameters such as build up, time since last clean, warning level setting, and presence of ink in gutter; printhead heater parameters such as set temperature, actual temperature, and drive; printhead cover parameters such as status (on or off) and time since last removed; the status of various printhead valves (open, closed, and time open or closed); nozzle parameters such as target velocity, drop frequency, print count, run hours, and drops deflected. The one or more sensors of the self-cleaning print head 1006 can therefore provide data relating to the operation of the self-cleaning print head 1006.

At Step S4, the continuous inkjet printer 1002 determines a service issue associated with the self-cleaning print head 1006 based on the sensor data. For example, the continuous inkjet printer 1002 may monitor the sensor data and may determine a problem that may affect the normal running of the self-cleaning print head 1006. Such a service issue may be, for example, the detection of a build-up of debris in or around a gutter of the self-cleaning print head 1006, or could be the detection of an EHT trip. For example, a gutter build up sensor may be used to determine the build-up of debris in or around the gutter. Another service issue may be the detection of a phase signal that does not meet a defined set of rules for an extended period of time. The determination of the service issue may indicate that maintenance is required.

At Step S5, the continuous inkjet printer 1002 executes a self-cleaning operation of the self-cleaning print head 1006 in response to the determined service issue. As noted above, it may be advantageous to carry out a cleaning operation at specific times, such as when the production line 1001 is halted. Therefore, the continuous inkjet printer 1002 may send, prior to executing the self-cleaning operation and in response to the determination of the service issue, data indicative of the service issue to the external controller 1009. The continuous inkjet printer 1002 may then wait until it receives a control signal as described above before carrying out the self-cleaning operation. Upon receiving the data indicative of the service issue, the external controller 1009 determines a suitable time at which to send the control signal to the continuous inkjet printer 1002, as described above. In this way, the self-cleaning operation can be carried out at a suitable time taking into account the overall operation of the production line 1001.

Additionally, or alternatively, the continuous inkjet printer 1002 may comprise first and second self-cleaning print heads, where when the first self-cleaning print head is being cleaned, the second self-cleaning print head can operate in place of the first self-cleaning print head. For example, the second print head may be considered a spare print head that is not used during normal usage, and only used when the first print head is being cleaned (or otherwise out of action). For example, on receipt of the control signal described above, the continuous inkjet printer 1002 may stop using the first self-cleaning print head to mark products 1008 on the production line 1001, start cleaning the first self-cleaning print head, and start operating the second self-cleaning print head to mark products 1008 in place of the first self-cleaning print head. In examples where the continuous inkjet printer 1002 has multiple print heads that can be used in place of one another, the timing of the control signal may not be so critical. That is, where the second self-cleaning printhead can be used in place of the first self-cleaning printhead, there is no need to halt the production line in order to carry out cleaning. In such examples, the external controller 1009 may then send the control signal to the continuous inkjet printer 1002 at any suitable time, such as a time corresponding with a predetermined elapsed time since the previous cleaning operation.

FIG. 13 shows a computing apparatus 1040 configured to carry out the methods disclosed herein. The external controller 1009 and/or the continuous inkjet printer 1002 may comprise the computing apparatus 1040. The computing apparatus 1040 comprises a processor 1040a which is configured to read and execute instructions stored in a volatile memory 1040b which takes the form of a random access memory. The volatile memory 1040b stores instructions for execution by the processor 1040a and data used by those instructions.

The computing apparatus 1040 further comprises non-volatile storage in the form of a hard disc drive 1040c. The computing apparatus 1040 further comprises an I/O interface 1040d to which are optionally connected data capture and peripheral devices used in connection with the computing apparatus 1040. In the example shown, a display 1040e is connected to the I/O interface 1040d to display output from the computing apparatus 1040. The display 1040e may be provided locally to the external controller 1009 (e.g. as a screen), or remotely from the external controller 1009. For example, a display associated with a separate device (e.g. a mobile computing device) may be used as a display for the external controller 1009. Additionally or alternatively, a touchscreen associated with the display 1040e may operate as a user input device, so as to allow a user to interact with the computing apparatus 1040. Alternatively or additionally, separate input devices may be also connected to the I/O interface 1040d, such as a mouse and/or keyboard. A network interface 1040f allows the computing apparatus 1040 to be connected to an appropriate computer network so as to receive and transmit data from and to other computing devices, such as the continuous inkjet printer 1002. The processor 1040a, volatile memory 1040b, hard disc drive 1040c, I/O interface 1040d, and network interface 1040f, are connected together by a bus 1040g. The computing apparatus 1040 may be connected to an external computer/server via the network interface 1040f.

Although the disclosure has been described in terms of preferred embodiments as set forth above, it should be understood that these embodiments are illustrative only and that the claims are not limited to those embodiments. The skilled person will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein.

1. A computer implemented method for cleaning a self-cleaning marking head of an industrial printer, the method comprising:
receiving, by the industrial printer and from an external controller, a control signal; and
executing, by the industrial printer, a self-cleaning operation of the self-cleaning marking head in response to receiving the control signal.

2. The computer implemented method according to claim 1, wherein the self-cleaning operation comprises an intrinsic cleaning operation.

3. The computer implemented method according to claim 1, wherein the self-cleaning operation does not comprise the use of an external cleaning apparatus.

4. The computer implemented method according to claim 1, wherein the industrial printer is a continuous inkjet printer and the self-cleaning marking head is a self-cleaning print head.

5. The computer implemented method according to claim 4,
wherein the self-cleaning operation comprises actuating a sealing mechanism of the self-cleaning print head from a first configuration, in which a chamber of the self-cleaning print head is in communication with atmosphere via at least an ink aperture, to a second configuration in which the chamber is sealed.

6. The computer implemented method according to claim 5, wherein the self-cleaning operation further comprises directing a cleaning fluid into the chamber to clean the chamber.

7. The computer implemented method according to claim 5,
wherein the sealing mechanism comprises a rotatable body rotatable about an axis of rotation between the first configuration and the second configuration, and
wherein actuating the sealing mechanism of the self-cleaning print head from the first configuration to the second configuration comprises:
rotating the rotatable body of the sealing mechanism of the self-cleaning print head from the first configuration to the second configuration in which the chamber is sealed by the rotatable body.

8. The computer implemented method according to claim 6, wherein the chamber comprises a plurality of ports, the method further comprising:
selecting, by the continuous inkjet printer, a port of the chamber as a fill port, and a port of the chamber as a drain port, based upon the orientation of the self-cleaning print head;
wherein directing the cleaning fluid into the chamber to clean the chamber comprises directing a flow of cleaning fluid through the fill port, into the chamber, to clean the chamber; and
draining the cleaning fluid from the chamber, through the drain port, to drain the chamber.

9. The computer implemented method according to claim 1, wherein the control signal having been sent based on a predetermined condition being satisfied.

10. The computer implemented method according to claim 9, wherein the predetermined condition is a status of a production line on which the industrial printer is operating.

11. The computer implemented method according to claim 10, wherein the status comprises a halt on the production line on which the industrial printer is operating.

12. The computer implemented method according to claim 9, wherein the predetermined condition comprises a predetermined time.

13. The computer implemented method according to claim 1, the method further comprising:
sending, by the external controller, the control signal to the industrial printer.

14. The computer implemented method according to claim 1, further comprising:
determining, by the industrial printer, completion of the self-cleaning operation;
sending, by the industrial printer, data indicating that the self-cleaning operation is complete to the external controller.

15-37. (canceled)

38. A system comprising:
an external controller configured to receive a control signal; and
an industrial printer coupled to the external controller, wherein the industrial printer comprises a self-cleaning marking head, the industrial printer configured to,
receive the control signal; and
execute a self-cleaning operation of the self-cleaning marking head in response to receiving the control signal.

39. A computer readable medium storing computer readable instructions, which when executed by one or more processors cause the one or more processors to perform operations for cleaning a self-cleaning marking head of an industrial printer, the instructions comprising:
instructions to receive, by the industrial printer and from an external controller, a control signal; and
instructions to execute, by the industrial printer, a self-cleaning operation of the self-cleaning marking head in response to receiving the control signal.

40. The computer implemented method according to claim 9, wherein the predetermined condition comprises an elapsed time since a last failure of the industrial printer.

41. The computer implemented method according to claim 9, wherein the predetermined condition is based on environmental data, the environmental data comprising ambient humidity, temperature, and/or pressure in the environment in which the industrial printer is operating.

42. The computer implemented method according to claim 41, wherein the predetermined condition is a predetermined time over which one or more of the humidity, temperature and/or pressure are above or below a predetermined level.

43. The computer implemented method according to claim 1, wherein the control signal is transmitted wirelessly.
